(19) United States
(12) Patent Application Publication
(10) Pub. No.: US 2015/0005197 A1
(43) Pub. Date: Jan. 1, 2015

(54) Ultrasensitive Assays With A Nanoparticle-Based Photonic Crystal

(71) Applicant: THE REGENTS OF THE UNIVERSITY OF CALIFORNIA, Oakland, CA (US)

(72) Inventors: Ian M. Kennedy, Davis, CA (US); Jin-Hee Han, Davis, CA (US); Sudheendra Lakshmana, Davis, CA (US)

(73) Assignee: The Regents of the University of California, Oakland, CA (US)

(21) Appl. No.: 14/370,829

(22) PCT Filed: Jan. 7, 2013
(86) PCT No.: PCT/US13/20597

§ 371 Date: Jul. 7, 2014

Related U.S. Application Data
(60) Provisional application No. 61/584,230, filed on Jan. 7, 2012.

(51) Int. Cl. G01N 21/77; B01J 19/00; G01N 21/64

(52) U.S. Cl. CPC G01N 21/774; G01N 21/6452; B01J 19/0046; B01J 2219/00698
USPC 506/14; 506/18; 506/23

(57) ABSTRACT

A photonic crystal-immunoassay platform wherein the periodicity of wells in an array are designed based on the leaky wave-guided modes of high refractive index material and a wavelength of excitation and/or emission of electromagnetic radiation associated with a signal used in the assay.

### CROSS REFERENCE TO RELATED APPLICATIONS

This application claims the benefit of the earlier filing date of U.S. Provisional Application 61/584,230 filed Jan. 7, 2012 which is incorporated by reference in its entirety for all purposes.

### STATEMENT REGARDING FEDERALLY SPONSORED RESEARCH OR DEVELOPMENT

This invention was made with government support under P42ES004699 awarded by the National Institutes of Health and 2005-35603-16280 awarded by United States Department of Agriculture. The government has certain rights in the invention.

### FIELD

The present disclosure relates to a nano-particle-based photonic crystal array for high sensitivity immunoassays.

### BACKGROUND

Conventional microarrays have facilitated many breakthroughs in life sciences by identifying specific gene sequences or protein analytes. However, there is a need for further reduction in size to a nano scale. Such reduction in size offers significant advantages, particularly improvement in the assay speed as diffusion becomes less limiting. But the reduction in the size of an array poses problems that are related to a low signal to noise ratio and detectability of the signal. The size of the spots in a microarray is limited by optical resolution to dimensions of approximately a visible wavelength.

Photonic crystals (PC) have been applied in a variety of ways for enhanced biosensing. PC's have been assembled via colloids (H. Li, et al. J. Colloid Interface Sci. 356, 63-68 (2011) and Shen, W. Z. et al. Biosens. Bioelectron. 26, 2165-2170 (2011)) but this leads to complex structures that are not robust and ideal for disease diagnosis and proteomics. Ganesh et al. explored leaky modes in nanostructures to enhance emission from embedded quantum dots (Nat. Nanotechnol. 2, 515-520 (2007)). More recently the same group has demonstrated up to 89% enhancement in the limits of detection of cancer biomarkers with a Cy5 dye and photonic structure. The commercial BIND assay is an example of real-world application of nanostructures to provide enhanced detection, in this case without labels. In these examples however, the sensing element was attached to the surface of the photonic crystal.

There continues to be a need for assays with extremely low levels of detection which are robust.

### SUMMARY

In one embodiment is provided a nanoarray comprising: a first substrate; a second substrate deposited on said first substrate, said second substrate having a high refractive index and having at least one of a waveguide mode or a leaky mode; a superstrate disposed on the second substrate comprising a plurality of wells, said plurality of wells having a periodicity based on said waveguide mode or said leaky mode and one of an excitation wavelength or an emission wavelength for a signal to be measured.

In some embodiments, said nanoarray further comprises a nanoparticle disposed in at least one of said plurality of wells.

In some embodiments, said nanoparticle further comprises a fluorescent tag.

In some embodiments, said nanoparticle further comprises an antibody.

In some embodiments, said nanoparticle further comprises a bacteriophage.

In some embodiments, said nanoarray further comprises a bacteriophage disposed in at least one of said plurality of wells.

In some embodiments, said plurality of wells have a diameter of less than 100 nm.

In some embodiments, said plurality of wells comprise a plurality of diameters.

In some embodiments, said signal to be measured is an optical signal.

In some embodiments, said periodicity is based on said waveguide mode or said leaky mode, said excitation wavelength and said emission wavelength for a signal to be measured.

In some embodiments, said nanoarray comprises a photonic crystal.

Also provided is a method of constructing a nanoarray comprising: depositing a first substrate; depositing a second substrate having a waveguide mode or a leaky mode on said first substrate; depositing a superstrate on said second substrate; determining periodicity for a plurality of nanowells to be created in said superstrate based on said waveguide mode or said leaky mode and one of an excitation wavelength or an emission wavelength for a signal to be emitted from one of the plurality of nanowells; and creating said plurality of nanowells in said superstrate, said plurality of nanowells having said determined periodicity.

In some embodiments, the method further comprises disposing nanoparticle in each one of said nanowells.

In some embodiments a size of said nanoparticle is determined based upon a size of at least one of said plurality of nanowells.

In some embodiments said plurality of nanowells have a plurality of diameters.

In some embodiments said periodicity is determined using the equation D=λm/n₂·cos (φ) wherein D=periodicity; λ is said wavelength; m is an order of diffraction; n₂ is a refractive index of said second substrate and φ is an internal diffraction angle between diffracted light and a surface of the nanoarray.

In some embodiments said refractive index of said second substrate is 1.

### BRIEF DESCRIPTION OF THE DRAWINGS

FIGS. 1, 5B-5G, 7A-7B and 8 are grey-scale images of a colored heatmap from dark blue to dark red wherein the areas enclosed in a solid white line represent the dark blue end of the spectrum and the areas enclosed in a dashed white line represent the dark red end of the spectrum.

FIG. 1 illustrates finite element modeling of the modes of the electric field when excited by a plane wave of 532 nm from above.

FIG. 2 illustrates detection of IgG with an array built according to model of FIG. 1.

FIG. 3 illustrates the generation of the array.

FIGS. 4A-4F illustrate the nano- or micro arrays/well with fluorescent carboxylated polystyrene particle (ex: 650 nm, em: 690 nm) conjugated with goat-anti-rabbit IgG located to corresponding wells based on the size of particle after trapping using the EPES.

FIG. 5A shows the 3-D geometry of the nanostructured microarray with boundary conditions used in the model (v: 50 nm; l: 240 nm (85 nm-PMMA and 155 nm-LOL; PMMA and LOL 2000 were assumed to be single layer in the model), a: 1.1 mm).

FIGS. 5B-G show the spatial distribution of the electric field intensity confined within the PC.

FIG. 6 shows the standard curves for four different arrays based on the size of particles.

FIGS. 7A-B illustrate a numerical model based on this structure confirmed the formation of modes within this periodic structure.

FIGS. 7C and 7D show the experimental standard curve for a rabbit IgG immunoassay using an optimized array of 40 nm wells with 350 nm-periodicity.

FIG. 8 illustrates energy density time average as a function of frequency showing resonance. The top of the scale represents the dark red end of the spectrum and the bottom end of the scale represents the dark blue end of the spectrum. With the exception of the approximate quarter circle portions encompassed in dashed white lines, the fill of the figure is shades of blue.

FIG. 9 shows the resulting standard curve for the HER2 immunoassay using the optimized array of 40 nm wells with 350 nm-periodicity (♦) as well as the standard curve obtained from the corresponding conventional ELISA (x) was compared.

FIG. 10 illustrates a method of fabricating of photonic nano-micro-arrays/wells.

FIG. 11 shows the schematic of an epi-fluorescent single photon counting detection system.

FIG. 12 illustrates the steps of generating phages and trapping them in a photonic crystal array.

FIG. 13 are a fluorescent microscope images of SYBR green labeled T7 phages trapped in a photonic crystal array (25 μm×25 μm) created on ITO coated glass slide.

FIG. 14 shows a non-competitive fluorescent-based immunoassay in the nanowell array using EPES.

FIG. 15 demonstrates a non-competitive fluorescent-based immunoassay in the nanowell array using EPES of SEB protein biomarker in PBS buffer.

### DETAILED DESCRIPTION

Unless otherwise stated, the following terms used in this application, including the specification and claims, have the definitions given below. It must be noted that, as used in the specification and the appended claims, the singular forms “a,” “an” and “the” include plural referents unless the context clearly dictates otherwise. The practice of the present invention will employ, unless otherwise indicated, conventional methods of biology, chemistry and spectroscopy.

Any terms not directly defined herein shall be understood to have the meanings commonly associated with them as understood within the art of the invention. Certain terms are discussed herein to provide additional guidance to the practitioner in describing the compositions, devices, methods and the like of aspects of the invention, and how to make or use them. It will be appreciated that the same thing may be said in more than one way. Consequently, alternative language and synonyms may be used for any one or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples, including examples of terms, is for illustrative purposes only and does not limit the scope and meaning of the aspects of the invention herein.

All references, issued patents and patent applications cited within the body of the specification and appendix are hereby incorporated by reference in their entirety, for all purposes.

### INTRODUCTION

Disclosed herein is a simple PC-immunoassay platform and methods for fabricating the same. The platform includes a photonic crystal coupled to a pixilated microarray. The periodicity of the wells in the photonic crystal array are designed based the leaky wave-guided modes of the high refractive index material of which the array is made. In some embodiments the periodicity of the wells is further designed using the wavelength of an electromagnetic signal to be detected. In some embodiments, the periodicity of the wells is further designed using a wavelength of electromagnetic radiation used to excite the sample resulting in a signal to be detected. In some embodiments, the periodicity of the wells is further designed using both the excitation and emission wavelengths involved in the detection of the assay. The electromagnetic signal to be detected may emanate from the analyte of interest to be measured or from a tag added to the analyte of interest. In either case that signal may result from the analyte of interest or tag with or without initial excitation with electromagnetic radiation. In some embodiments either the excitation or emission radiation, or both, are in the optical spectrum.

This design provides significant enhancements in detection. Surprisingly, using nanoparticles provides orders of magnitude improvement in limits of detection over using microparticles. The photonic crystal also serves as an electrophoretic particle entrapment system (EPES) to generate nanopixels.

Preferably the nanoparticles and thus the wells are less than 100 nm as this size allows for better exploitation of the enhanced fluorescent excitation and extraction that is afforded by coupling to the nano-photonic crystal structure with optimized periodicity. In one embodiment, the nanoparticles are polystyrene beads. Multiplexed arrays are prepared by adding particles step-wise from largest to smallest to the wells of the nanoarray.

In one embodiment, nanoparticles with antibodies attached are captured in wells on the chip. Antibodies are conjugated to the surface of nanoparticles passively or covalently. Not all antibodies attached to nanoparticles need to be the same. By tailoring the surface charge of the nanoparticles with various functional groups (e.g., carboxylic/amine groups) or by embedding super-paramagnetic particles within charged nanoparticles allows for directing nanoparticles with different antibodies to the desired location on the array. Additionally, different size nanoparticles can be used for different antibodies. In such an embodiment, an array with wells sized for each of the different antibody-nanoparticle conjugates is prepared. The multiplex array is assembled by adding the various nanoparticle-antibody conjugates from largest to smallest such that they end up in the correct-sized well.

In some embodiments, polystyrene nanoparticles that are functionalized with streptavidin are immobilized into the nanowells with the EPES method. With a bacteriophage-based analytical method, targeted pathogenic bacteria are infected by these viruses, leading the production of secondary phages. As secondary phages are flowed over the nanowells, an electrostatic potential is applied to direct the phages, with their net charge, towards the wells where binding of their biotin to the immobilized streptavidin can take place, overcoming the kinetic limitation that would be imposed by slow diffusion of the relatively massive phages.

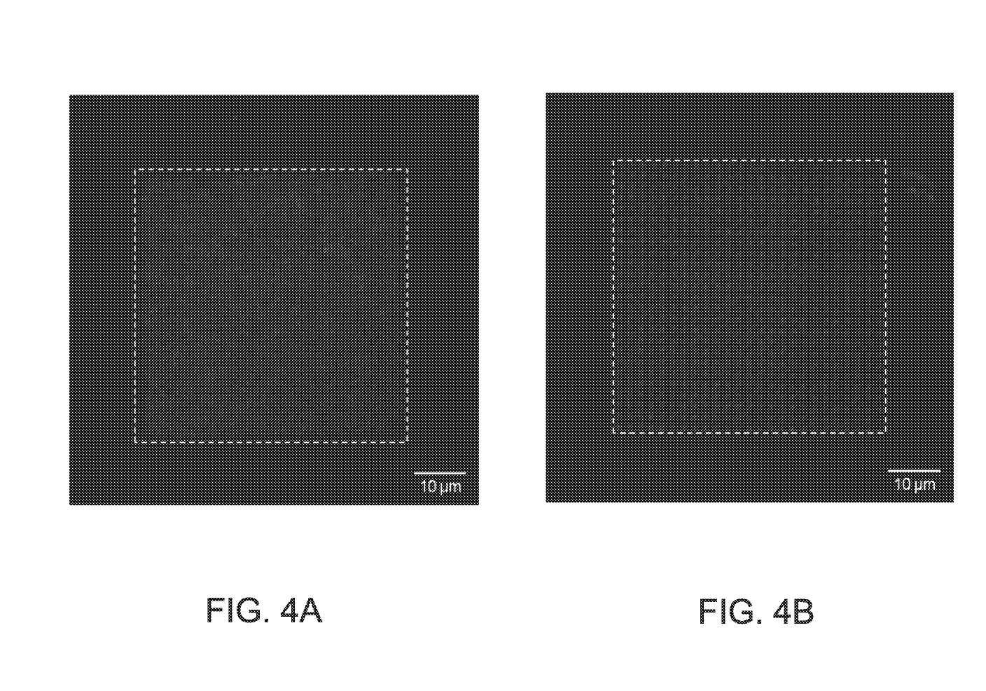

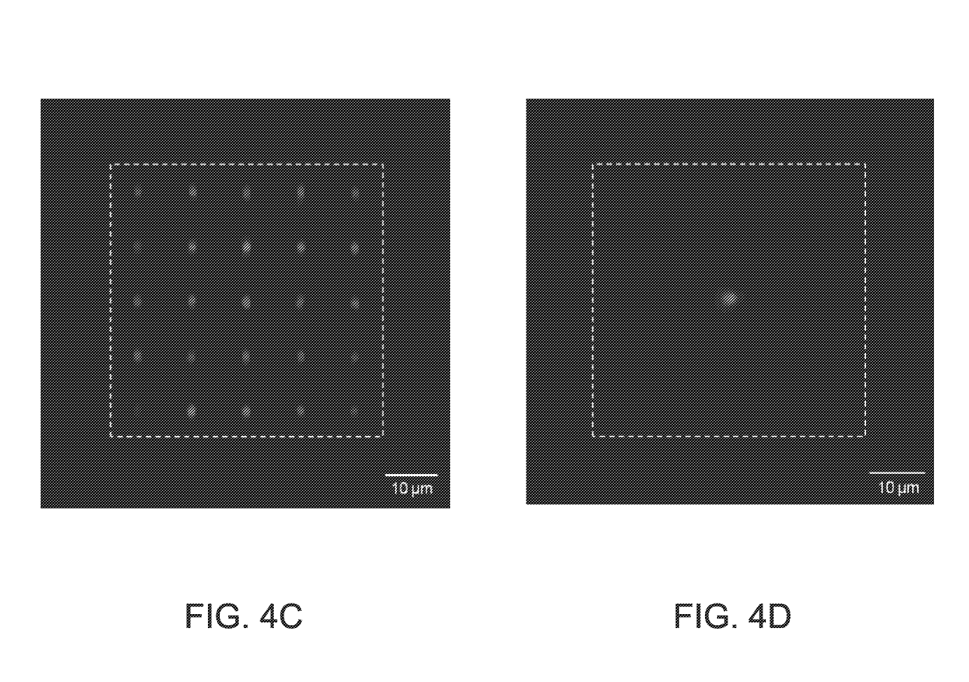

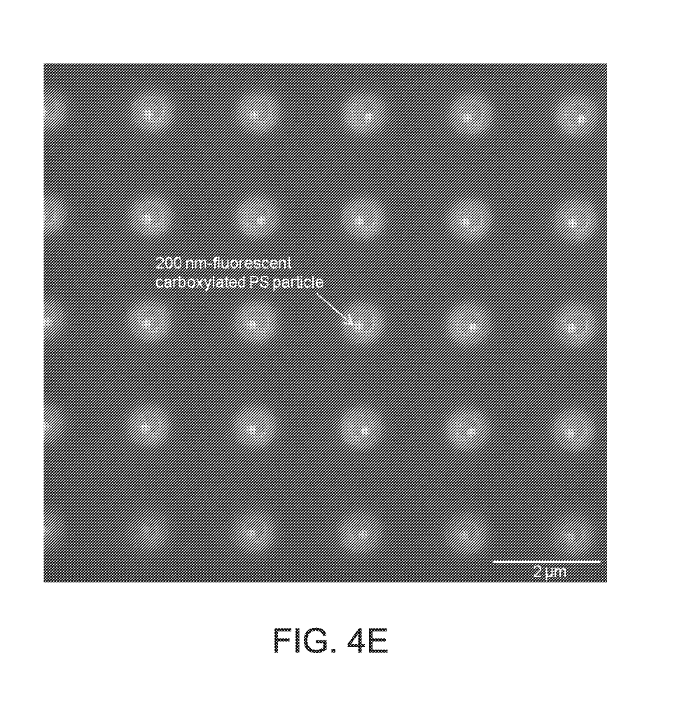

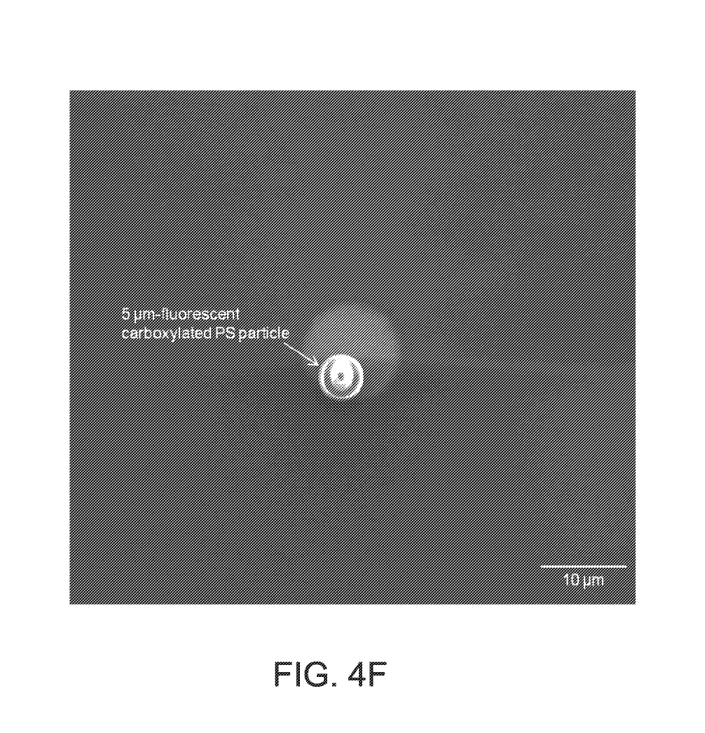

The disclosed nanoparticle-based immunoassay achieves attomolar sensitivity with high signal to noise ratio, especially from a microspot that is pixelated with a PC structure. Particles are commonly used as solid supports for antibody immobilization to improve the control of antibody concentration, to improve the speed of assays, and to facilitate separation from solution by making use of the well-controlled surface area, surface charge, functional groups and choice of signal transduction that particles can provide. The disclosed nanoparticle-based immunoassay combines the advantages of particle-based assays and uses the particles to construct a well-ordered nanoscale array of particles in a fast, efficient manner. Negative charges on the carboxylated particles enable use of electrophoretic transport for localizing particles to nanoscale wells with an electrically conductive substrate (ITO) with positive charge at the bottom of each well. In terms of realizing a PC structure, a solid immunocomplex consisting of capture antibodies, analytes and detection antibodies plus fluorophores sitting on the high refractive index substrate (ITO) exploits the fluorescence excitation due to leaky modes created from the guided mode resonances confined in both the superstrate (PMMA) and substrate (ITO). In order to achieve a regular PC structure, reliable and consistent deposition of particles into their corresponding nanowells is used: the EPES method demonstrated 100% trapping efficiency given sufficient time (FIG. 4A-4F). By using a weak trapping force, the EPES resolved the problem of locating antibodies at multiple desired sites of the array in a short time. The size and location of the nanowells can be controlled leading to the possibility of high throughput assays.

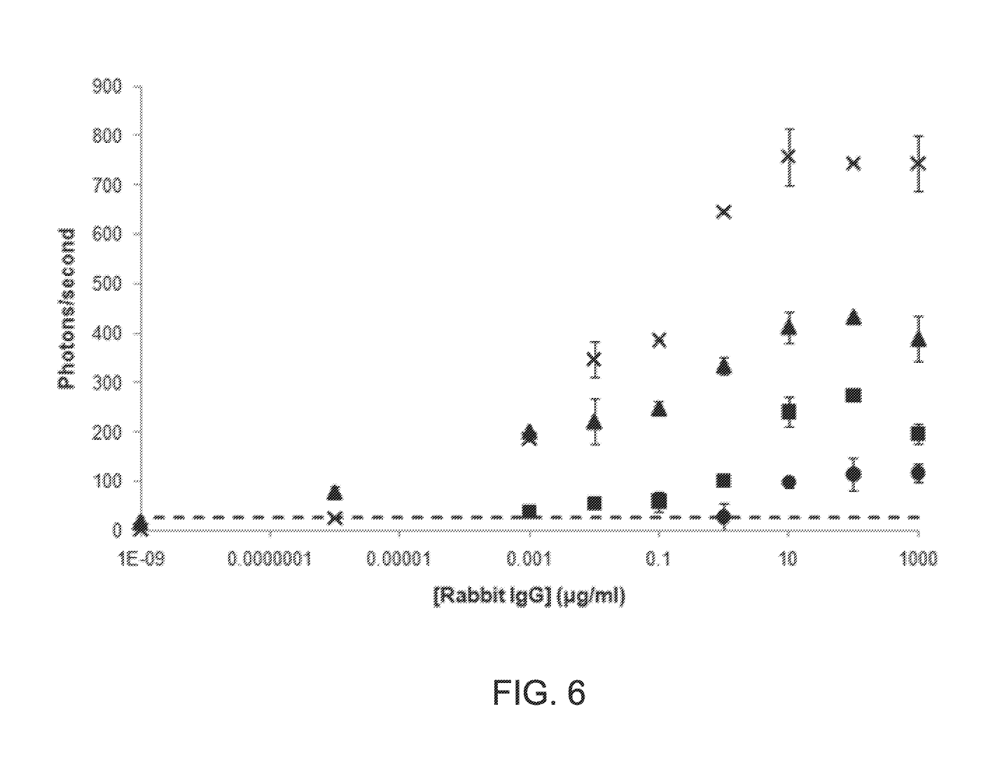

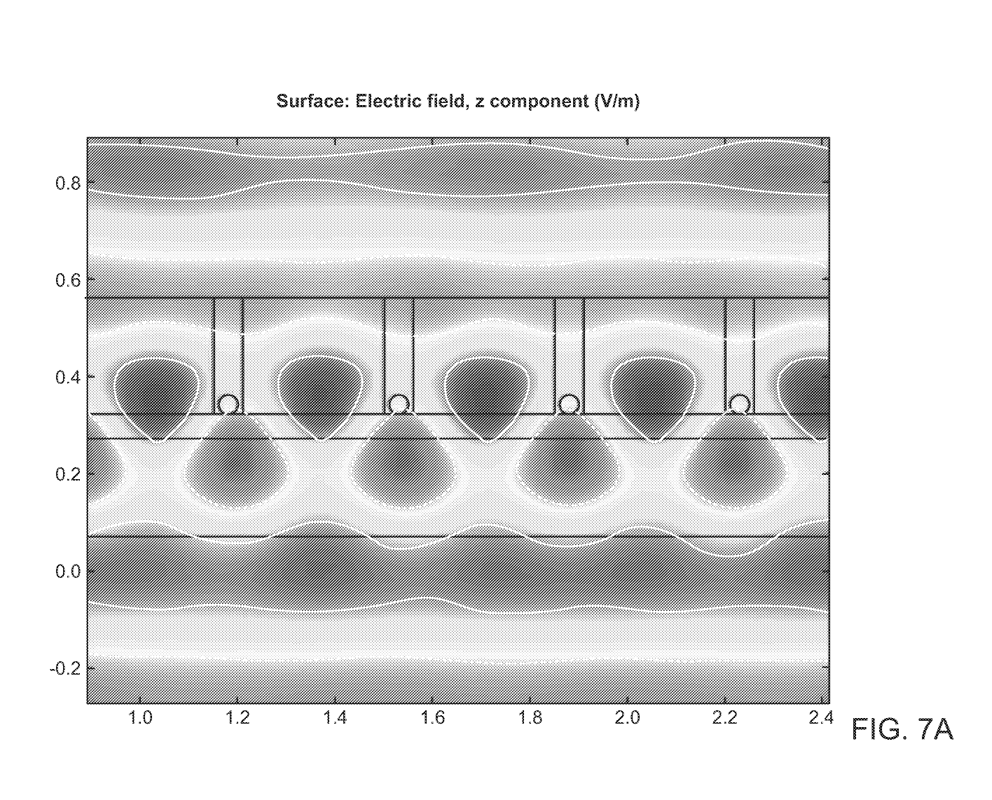

The combination of nanoparticles in an array of nanowells, constituting in effect a pixelated single micro-spot (52 μm×52 μm), achieves extremely low limit of detection (LOD). Pixelation of a microspot down to 40 nm with specific periodicity is an important factor in coupling the Bragg scattering with resonances in a PC structure for signal extraction. For 200 nm particles in the absence of resonance, diffraction still provides an enhancement of fluorescence. (Anal. Biochem. 313, 262-266 (2003)). Diffraction effects progressively vanish with an increase in the size of the particles, according for the observed increase in the LOD (FIG. 6). The effect is most pronounced for the optimal combination of the smallest nanoparticles and nanowells with the correct spacing for first order diffraction. The size and spacing of the nanowells is determined by the wavelengths of visible light that are used for excitation and emission. By comparing the LOD and log-linear detection range for a 40 nm-particles in a pixelated array with a 5 μm-single particle-well, the use of the single photon counting detection system was not, by itself, the most important factor in obtaining femtomolar and attomolar level sensitivity. In fact, the sensitivity in a 40 nm-particle pixelated nanoarray could be enhanced more than 1000 fold by optimizing just the PC structure of the array.

In the detection of cancer biomarkers in serum, careful rinsing procedures reduce false-positive effects that arise from other proteins in the serum. A one-time rinsing with 10 μm-droplet of deionized water results in highly effective particle removal in the EPES. Effectiveness of the simple rinsing is verified by demonstrating negligible values of the negative control compared to background noises using only serum. Protein fouling of carboxylated polystyrene particles was prevented due to the hydrophilic hairy surface provided by carboxyl groups. (Anal. Chim. Acta 584, 252-259 (2007)) Considering that the least amount time for immobilizing protein solution to bare PMMA surface is typically over one hour, the 20 min used for incubation time in the 40 nm-PC-nanoarray was not enough time for protein fouling.

With the used of 40 nm-particles in a pixelated-nanoarray with PC structure, the LOD was improved a million fold (10 aM) over the corresponding conventional ELISA for detecting HER2 in serum. This remarkably low LOD is well beyond the limit indicated by the equilibrium dissociation constant, K_{d}. Microspot assays by themselves are known to reduce the LOD well below the levels associated with K_{d}, due to increased density of capture antibody and lower limits of detectable detection antibody. (Anal. Chim. Acta 227, 73-96 (1989)) As the signal to noise ratio of the detection system is further improved in the disclosed system with the nanophotonic effect, further gains in LOD can be realized. A simple analysis shows that K_{d} is not the controlling factor under a set of limiting conditions. If the total antigen concentration [Ag]<<[Ab] where [Ab] is the total available antibody concentration, then [Ab] is approximately constant. Furthermore, if [Ab]>>K_{d} then it is straightforward to show that the concentration of the bound complex [AgAb] is approximately independent of K_{d} and proportional to [Ag]. These conditions are satisfied with our assay system, and are only feasible as a result of the ultrasensitive detectability of the nanophotonic array and the small scale of the microspot.

This sensitivity is much higher than is needed for clinical application of the HER2 assay because the threshold level to determine the existence of breast cancer tumor is 15 ng/ml²³. However, this model assay serves to demonstrate the significant advantages of using a particle-based immunocomplex within a PC structure that is constructed with nanoparticles in wells.

A non-optimized array used to measure 3-PBA35 demonstrated a limit of detection of 0.0064 μg/L which corresponds to 30 pM. This represents a 16-fold enhancement of sensitivity compared to a conventional assay on solid support.

The disclosed arrays can be reused if electro- or magneto-phoretic methods are used to place the nanoparticles in the wells of the array and then to remove them as well, followed by the addition of new nanoparticles to the wells.

### Materials

40 nm-Fluorescent carboxylated polystyrene (PS)-nanoparticles (F-8789; ex: 660 nm em: 680 nm) were purchased from Invitrogen (Carlsbad, Calif.). 200 nm-Fluorescent carboxylated PS nanoparticles (FC02F/9770; 660/690) and 1 μm-fluorescent carboxylated PS microparticles (FC04F/8608; 660/690) were purchased from Bangs Laboratories (Fishers, Ind.). 5 μm-Fluorescent-carboxylated-PS-microparticles (2308; ex: 660/685) were purchased from Phosphorex (Fall River, Mass.).

Goat-anti-rabbit IgG and goat-anti-rabbit IgG-Alexa 532 used for capture antibody and detection antibody respectively were purchased from Invitrogen. Monoclonal capture antibody to HER2 (MAB1129), biotinylated polyclonal detection antibody to HER2 (BAF1129) and recombinant HER2 were purchased from R&D Systems, Inc. (Minneapolis, Minn.). Streptavidin-Alexa 532 was purchased from Invitrogen. TMB (3,3′,5,5′-tetramethylbenzidine) was purchased from Sigma-Aldrich (St. Louis, Mo.). Streptavidin-horseradish peroxidase (HRP) was purchased from Pierce Thermo Pierce Scientific (Rockford, Ill.).

Indium tin oxide (ITO) coated glass wafer (CG-81N-1515; resistance: 30-60Ω) was purchased from Delta Technologies (Stillwater, Minn.). All chemicals used for fabrication of the arrays/well were obtained from University of California Davis Northern California Nanotechnology Center Acetone (Sigma-Aldrich, St. Louis, Mo.), LOL-2000 (MicroChem, Newton, Mass.), 2% 950 PMMA A2 (MicroChem), 1:3 methyl isobutyl ketone (MIBK, Sigma-Aldrich), isopropyl alcohol (IPA, Mallinckrodt Baker) and CD-26 (tetramethylammonium hydroxide, MicroChem). 100×-infinity corrected objective lens (M Plan APO; NA: 0.7; working distance: 6.0 mm; focal length: 2 mm) was purchased from Mitutoyo (Kawasaki, Japan). The beam-splitter (FF545/650-D100), 532 nm-long pass filter (BLP01-532R-25), 532 nm notch filter (NF01-532U-25) and 633 nm notch filter (NF02-6335-25) were purchased from Semrock (Rochester, N.Y.). The single photon counting-avalanche photodiode (SPAD; SPCM-AQRH-13; dark count: 500 counts/s max) was purchased from PerkinElmer (Waltham, Mass.). The CCD camera (TCA-5.0C, 5.0 MP) for imaging the arrays/well with fluorescent particles was purchased from Tucsen Image Technology Inc. (FuJian, China).

### Methods

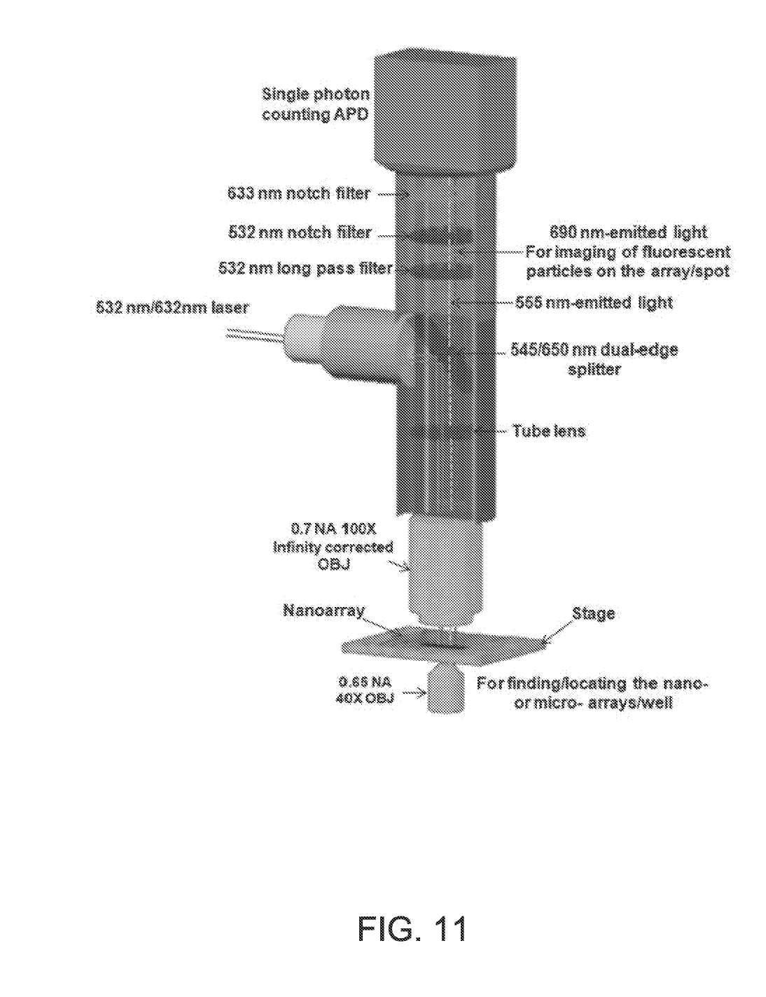

FIG. 11 shows the schematic of an epi-fluorescent single photon counting detection system. A particle trapped in the well was detected with a 100×-infinity corrected objective lens. A 532 nm CW laser was used to excite fluorescent probes of the immunocomplex. A 632 nm laser was used to image the fluorescent particles trapped into the wells. To guide the 532 nm- or 632 nm-laser to the nanoarray at sample stage and emitted light toward a SPAD or a CCD camera the dual edges-beam splitter was located before a 75 mm-focal length-convex lens that was used as a tube lens for the infinity corrected lens. The light emitted from the immunocomplex or fluorescent particles through the objective, tube lens and beam-splitter was filtered to eliminate the background of 532 nm- or 632 nm-band and simultaneously transmit all other wavebands by using 532 nm-long pass filter, 532 nm notch filter and 633 nm notch filter. The detection sites were confirmed with the 20×- or 10×-eyepieces. The photons of light emitted from the immunocomplex were then collected by the SPAD which generated a pulse per a photon. The pulses were counted by using an oscilloscope (WavePro 7000; Lecroy, Chestnut Ridge, N.Y.) connected to the SPAD.

### Array Chip Architecture

A glass substrate is coated with <100 nm indium tin oxide (ITO). ITO provides optically transparent electrodes for electrophoretic manipulation of nanoparticles. The top layer is polymethyl methacrylate (PMMA)

Fabrication of Periodic Nanowell Arrays with Suitable Geometries to Generate Resonance Guided Modes in the Substrate and the Superstrate

Method 1—After determining the label to be used in the assay and its emission wavelength, a standard e-beam lithography technique prepares nanoarray chips with different periodicity and depths of the wells predetermined by finite element modeling of the determined emission wavelength of the label(s) selected for the study. Modeling ascertains the periodicity and geometry of the arrays, resulting in an enhanced excitation and emission from the label. The modeling used is described in further detail in Example 5.

Method 2—Nanoimprint lithography a simple mechanical stamping of polymer coated substrates by molds—can also be used to prepare the nanowell arrays. As in the case of the e-beam technique, a customized stamp is developed based on the computer calculations using the determined emission wavelength of the label(s). The arrays are generated by stamping the pattern on PMMA held at its glass transition temperature (˜105° C.).

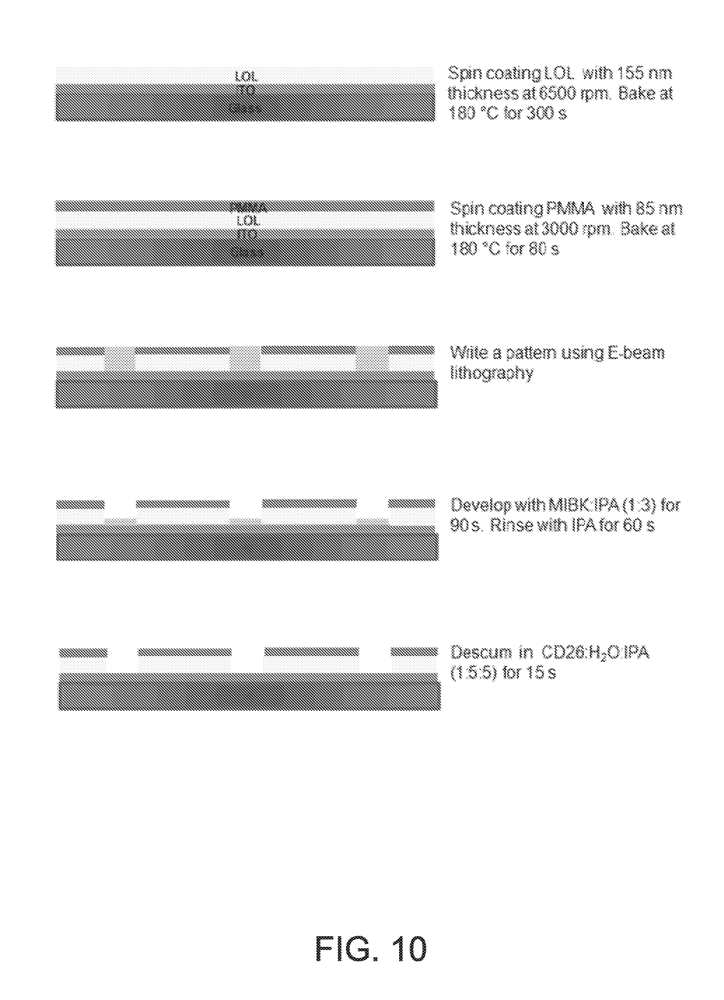

FIG. 10 illustrates a method of fabricating of photonic nano-micro-arrays/wells. The indium tin oxide (ITO) coated glass wafer was selected for its electrical and optical properties. High electrical conductivity of ITO was used for trapping the particles conjugated with biological molecules. On the other hand, the high refractive index of ITO contributed to create wave-guided modes in the nanoarrays. In addition, its optical transparency aids optic-based detection. Before coating the resist, the wafer was washed with acetone and fully spin-dried. 155 nm LOL-2000 was spin-coated on the wafer at 6500 rpm for 45 s followed by being baked at 180° C. for 300 s. After cooling the wafer, 85 nm 2% 950 PMMA A2 was spin-coated on the LOL-ITO-glass wafer at 500 rpm for 5 s followed by 3000 rpm for 45 s. The wafer was then placed on a hot plate at 180° C. for 80 s. Eventually, the bi-layer coating procedure made a total 240 nm thickness coating. The thickness was measured by an ellipsometer (Auto EL-2, Rudolph Research Analytical, Hackettstown, N.J., USA). The coated wafer was cut into 37.5 mm×25 mm chips. The chip was patterned using a scanning electron microscope (SEM) equipped with a nanometer pattern generation system (NPGS, FI 430 NanoSEM electron beam lithography system, FEI, Hillsboro, Oreg., USA) at 30 KeV, 24 pA beam current and 1.2 spot size. The chip was then developed using 1:3 MIBK/IPA for 90 S followed by being rinsed with IPA for 60 s. To fully eliminate any LOL-2000 residue that remained on the ITO surface, additional developing was performed by using 1:5:5 CD-26:H₂O:IPA for 15 s. The chip was rinsed with DI water and dried.

### Example 1

### IgG Immunoassay

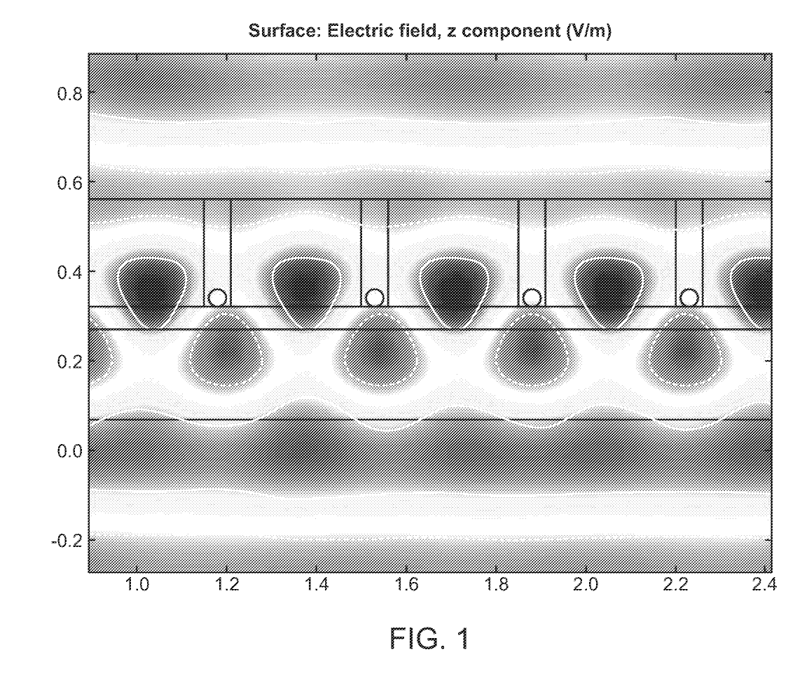

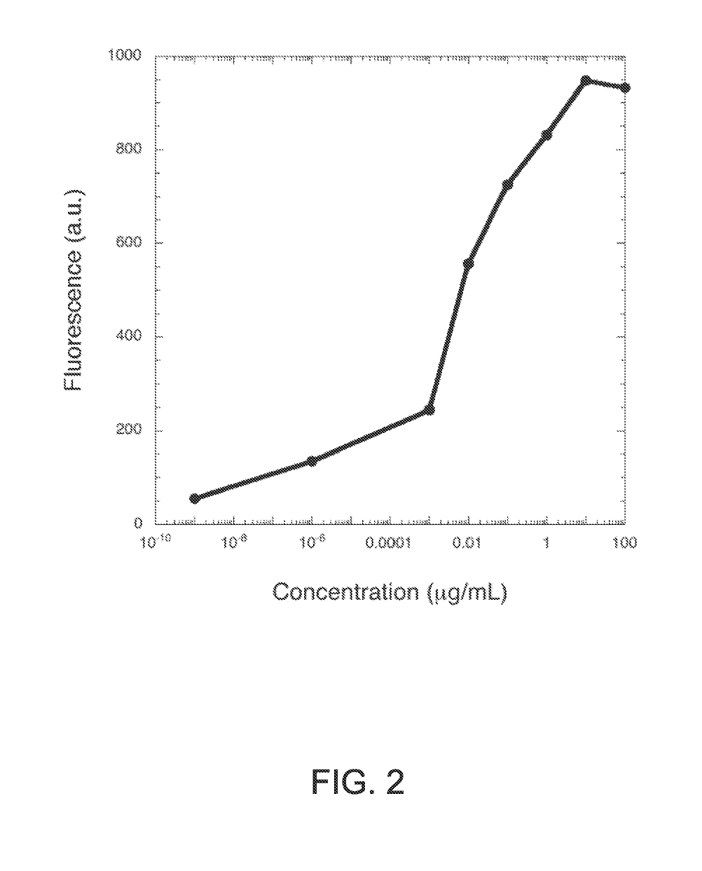

Finite element software was used to design periodicity of nanowells. The model is shown in FIG. 1. The 40 nm nanoparticles can be seen at the bottom of the 60 nm diameter wells. The electric field is amplified in the vicinity of the well. FIG. 2 demonstrates attomolar level detection of IgG was achieved with an array built according to the model in FIG. 1.

### Example 2

### Electrophoretic Particle Entrapment in Nano- or Micro-Wells

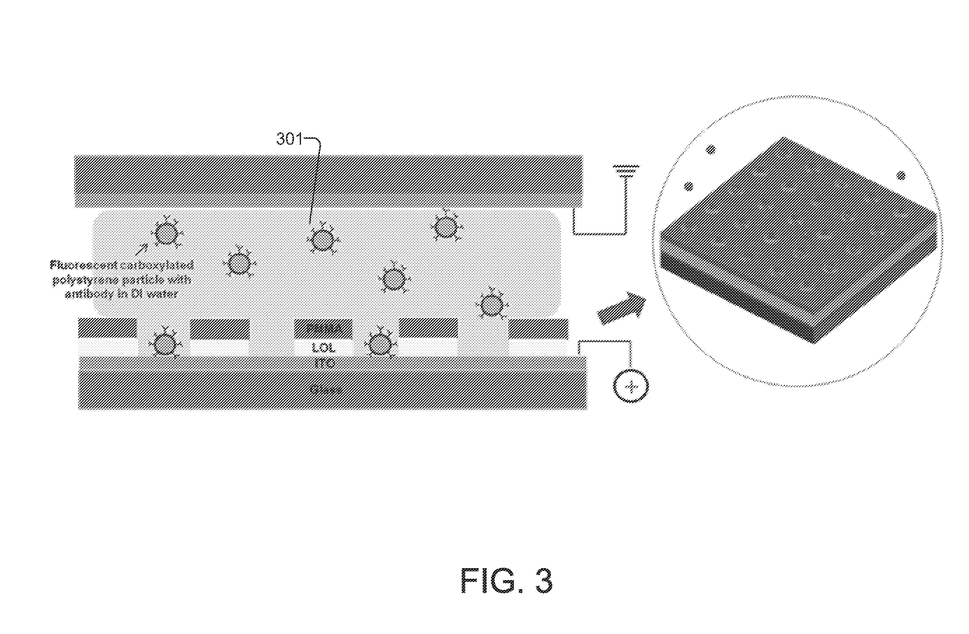

FIG. 3 illustrates the generation of the array. An electrophoretic particle entrapment system (EPES) was used to trap fluorescent carboxylated polystyrene particles 301 conjugated with capture antibodies into the PC structures engineered into the PMMA-LOL 2000-ITO-glass slide. The thickness of LOL 2000 and PMMA was 155 nm and 85 nm respectively. A PC patterned chip was placed on a solid mantle with another ITO-glass slide placed parallel on the top. The ITO at the bottom of the well was used as the electrode. The slides were each equipped with micro-scale manipulators to precisely control the location of the top and bottom slides horizontally or vertically. To create perpendicular electrophoretic forces, the bottom slide was connected to the positive electrical terminal while the top slide was connected to the ground terminal. The nanoparticles-deionized water solution was added to the surface of the patterned bottom slide as a droplet. The upper ITO-glass slide was then placed onto the droplet. The distance between two slides was 490 μm. The surface charge of the suspended particles was negative due to the carboxyl terminal group on the particles. After placing the top ITO-glass slide onto the droplet of particle solution and turning on the voltage, negatively charged particles migrated toward the surface of opposite electrical polarity. The EPES was operated for either 1 hour (40 nm and 200 nm nanoparticles) or 15 minutes (1 μm and 5 μm). The operating time was adjusted to accommodate varying surface charges on particles of different size, as revealed by Zeta-potential measurements. The Zeta potential was measured in 10 μl of liquid with a concentration of 0.05% (w/v) particles. The measured potential for 200 nm-particles was: −3.75×10⁻⁸ mV per one particle; for 1 μm-particles −6.79×10⁻⁶ mV per one particle; and for 5 μm-particles −2.44×10⁻³ mV per one particle. The applied voltage was 2 volts during the EPES process. Each particle conjugated with the antibodies was trapped into the wells based on their diameter and the size of the well.

FIGS. 4A-4F illustrate the nano- or micro arrays/well with fluorescent carboxylated polystyrene particle (ex: 650 nm, em: 690 nm) conjugated with goat-anti-rabbit IgG located to corresponding wells based on the size of particle after trapping using the EPES. After trapping, the solution between two slides was removed by sliding the top ITO-glass slide parallel to the bottom slide with the voltage still on. The surface tension of the droplet liquid was sufficient to remove untrapped particles from the surface. There was no additional rinsing procedure for removing non-specifically bound particles from the surface of the chip. Particles were not found to be bound to the surface of the PMMA as seen in FIGS. 4A-D. FIG. 4A illustrates fluorescent images of 40 nm-nanoarray with 650 nm-periodicity. FIG. 4B illustrates 200 nm-nanoarray with 2 μm-periodicity. FIG. 4C illustrates 1 μm-microarray with 10 μm-periodicity, FIG. 4D illustrates 5 μm-micro well. In addition, only a single particle was trapped into its corresponding well (FIGS. 4E-F). FIG. 4E illustrates scanning electron microscope (SEM) images of 200 nm-nanoarray with particles. FIG. 4F illustrates SEM images of 5 μm-micro well with particle. White broken line indicates detection area (52 μm×52 μm) where the excitation laser was focused and emitted fluorescent signal was collected

### Example 3

### Optical Mode Analysis

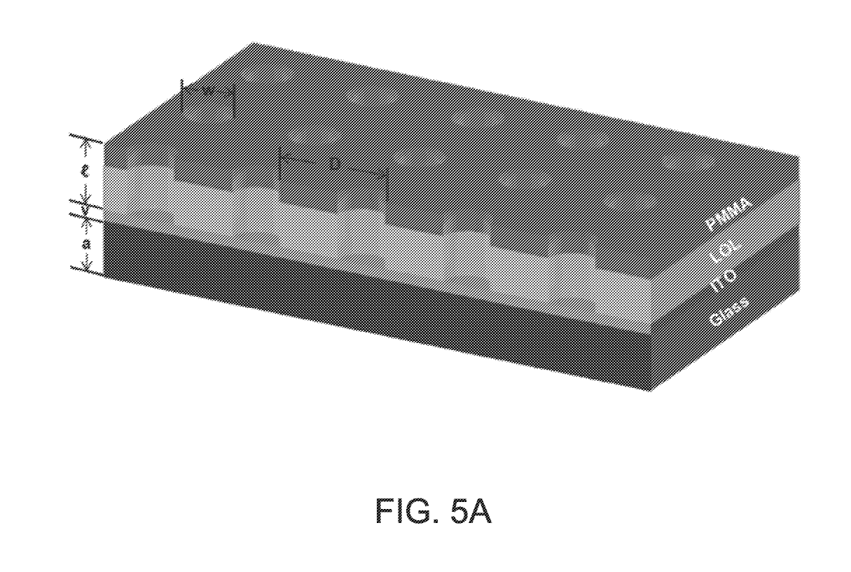

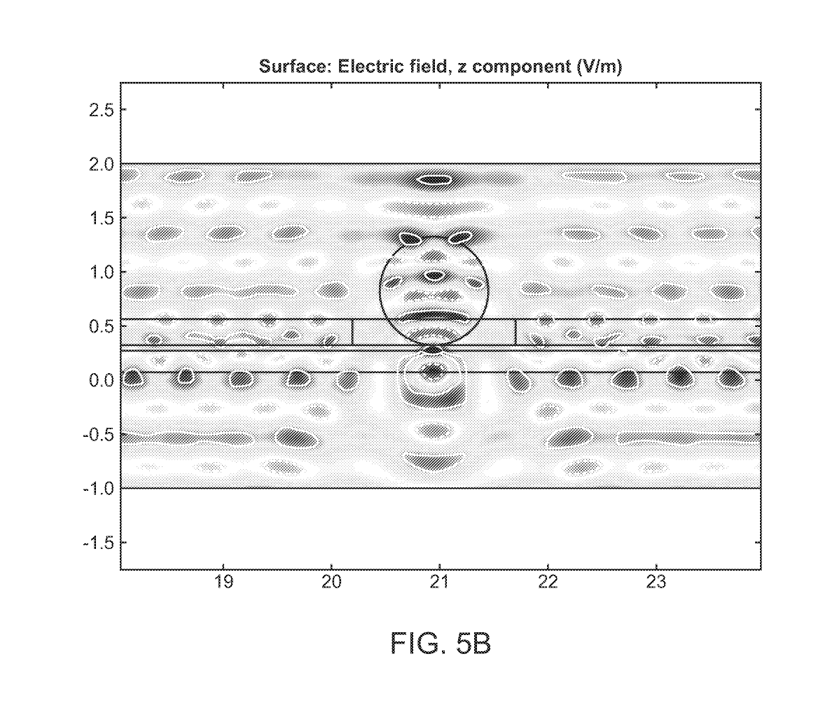

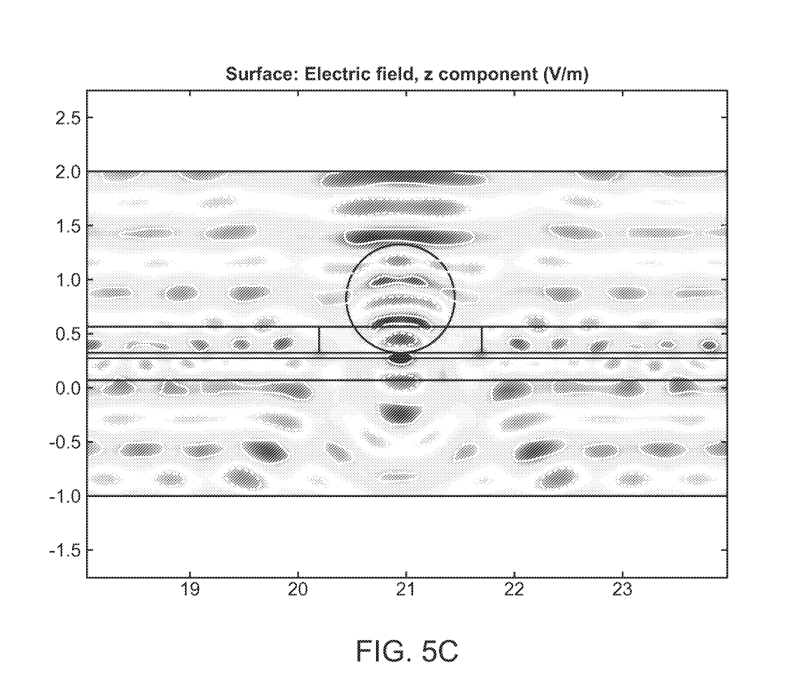

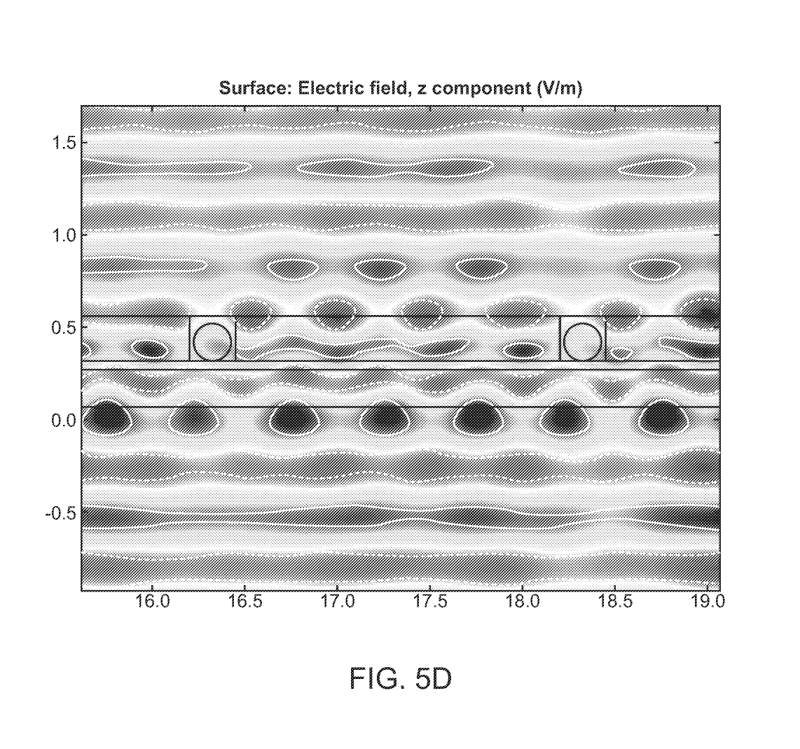

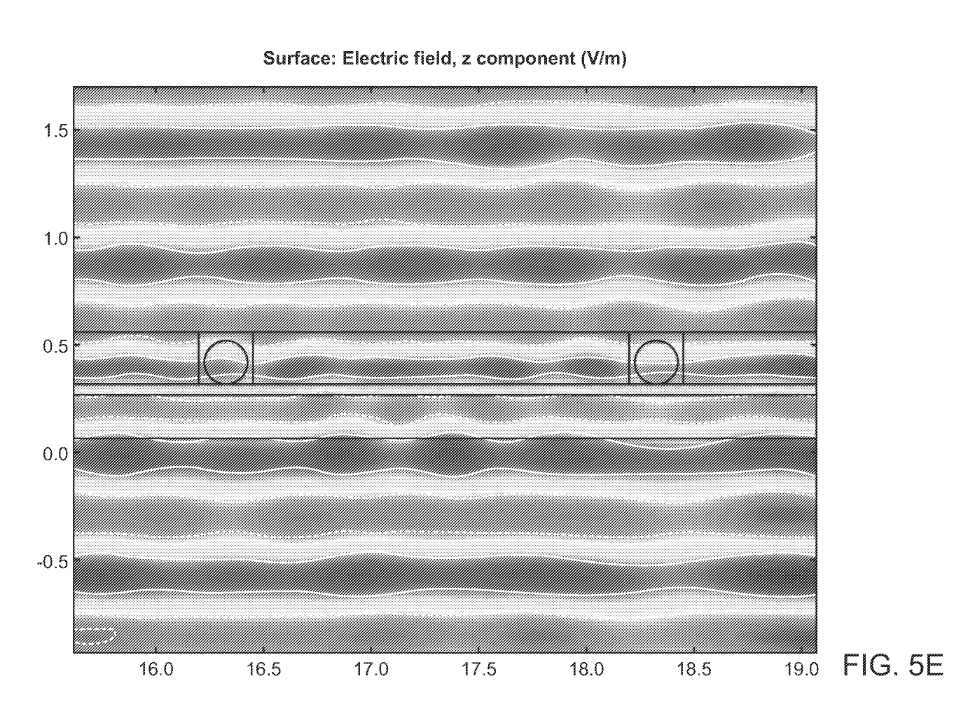

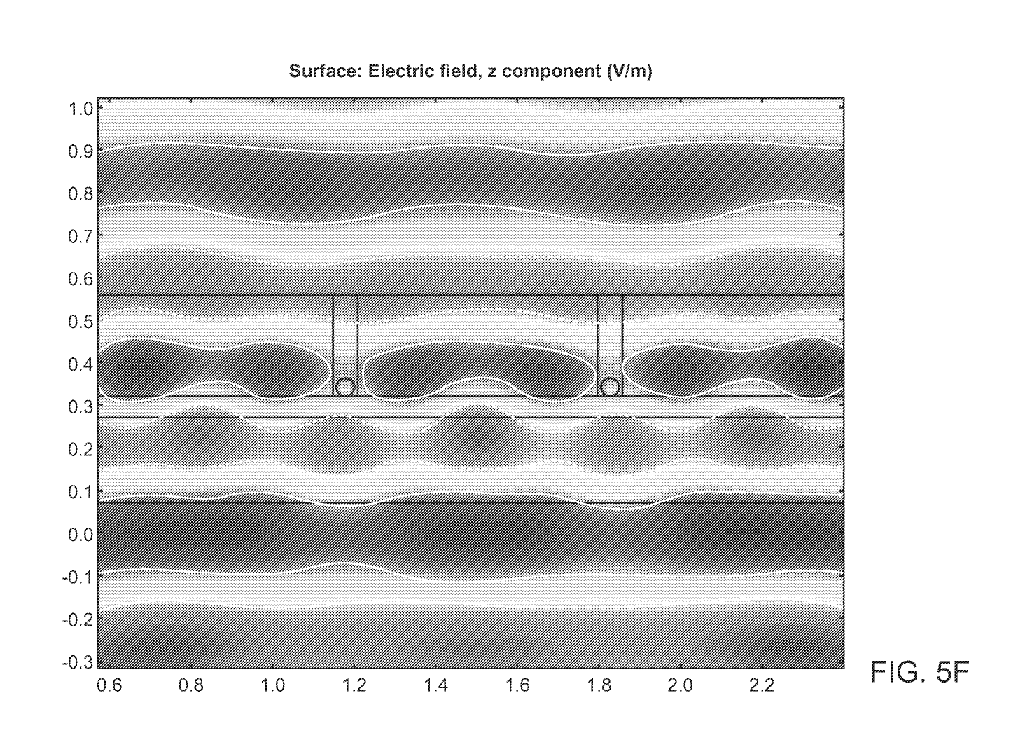

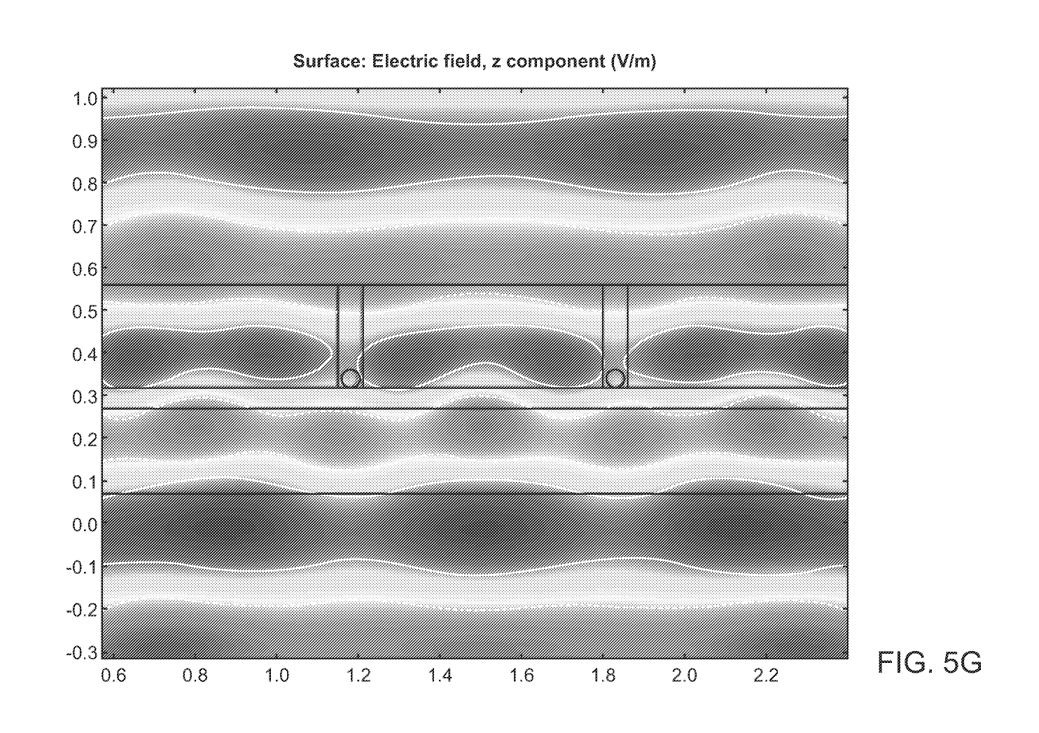

The interaction of the light with the PC structure was modeled by employing the electromagnetic wave model in the RF module of COMSOL Multiphysics (v. 4.1; COMSOL Inc, Burlington, Mass., USA). Normal incidence of the transverse electric (TE) field of the incoming electromagnetic wave was assumed, consistent with the experimental conditions. Maxwell's equations were solved for the given frequency, electric field of the TE mode of electromagnetic wave, and the refractive index and the geometry of the PC. FIG. 5A shows the 3-D geometry of the nanostructured microarray with boundary conditions used in the model (v: 50 nm; l: 240 nm (85 nm-PMMA and 155 nm-LOL; PMMA and LOL 2000 were assumed to be single layer in the model), a: 1.1 mm). The width (W) of the well and its periodicity was varied based on the size of the particles. Width/periodicity (D) was 60 nm/650 nm for 40 nm particles, 250 nm/2 μm for 200 nm particles, 1.5 μm/10 μm for 1 μm particles. The periodicity for different particles was chosen to provide uniformity of the particle distribution over the area of the array (52 μm×52 μm). In a given area of the array, the periodicity was varied such that the ratio of periodicity and the particle diameter was ˜10. The particle distribution with corresponding periodicity also provided almost the same surface area coated with capture antibodies for each particle size case (for 40 nm-nanoarray, the surface area is 2.85 times less than that of 200 nm-, 1 μm- and 5 μm-array/well). Table 1 shows the material properties of polymethyl methacrylate (PMMA), glass, polystyrene, air and indium tin oxide (ITO) used for modeling.

TABLE 1
Properties of materials used in the numerical model

| | | | | Electrical |
|---|---|---|---|---|
| | Refractive | Relative | Relative | conductivity |
| | index | permeability | permittivity | (S/m) |
| PMMA | 1.53 | 0.9 | 3.0 | 10⁻¹⁹ |
| Glass | 1.50 | 1.0 | 4.8 | 10⁻¹⁴ |
| Polystyrene | 1.55 | 0.9 | 2.5 | 10⁻¹⁶ |
| AIR | 1.0 | 1 | 1 | 10⁻³⁰ |
| ITO | 2.0 | 1 | 3.6 | 4500 |

In refractive index of the PMMA, the averaged value of PMMA (1.48) and LOL (1.58) was used.

The coating layer of the photoresists was assumed to be a single layer of PMMA because the difference of permittivity between the PMMA and LOL was not significant. A scattering boundary condition was adopted in the model. Based on the measured power of the 532 nm laser diode intensity focused on the PC, the boundary value of the incoming electric field was set to 6140 V/m. The electric fields at the other boundaries were set to zero. The same boundary conditions were used in all cases.

FIGS. 5B-G show the spatial distribution of the electric field intensity confined within the PC. Frequencies of the electromagnetic (EM) wave corresponded to the excitation (maximum 532 nm) and emission (maximum 555 nm) spectra of the fluorophore: 5.64×10¹⁴ Hz and 5.4×10¹⁴ Hz were used respectively. FIG. 5B illustrates spatial distribution of the electric field intensity confined within 1 μm-PC-microarray for 532 nm-wavelength. FIG. 5C illustrates spatial distribution of the electric field intensity confined within 1 μm-PC-microarray for 555 nm-wavelength. FIG. 5D illustrates spatial distribution of the electric field intensity confined within 200 nm-PC-nanoarray for 532 nm. FIG. 5E illustrates spatial distribution of the electric field intensity confined within 200 nm-PC-nanoarray for 555 nm. For a 40 nm-nanoarray with 650 nm-periodicity, the observed guided mode resonances were in a wavelength range (532 nm-555 nm) (FIGS. 5F and 5G).

To experimentally verify the presence of resonances due to the periodic nanostructure two different refractive index-materials, glycerin (refractive index: 1.47) and water (1.33) were added to the particle-based immunocomplex contained in the array of 40 nm wells. The intensity of the fluorescence was measured after the addition of each of the fluids and was compared to the intensity observed when air was the surrounding medium. For each test, rabbit IgG was used to construct the immunocomplex on the particles under the same conditions that were used for the main experiments. The addition of water to the top of the chip caused a 1.3 times decrease in the measured fluorescence; the addition of glycerin caused a six fold reduction in fluorescence signal (Table 2). The reduction of signal with reduction in relative difference in refractive index is consistent with the presences of resonances that support enhanced fluorescence detection.

TABLE 2
Fluorescent signals on a 40 nm-nanoarray with 650 nm-periodicity
using two different refractive index materials-periodic structures

| | Glycerine-PMMA | Water-PMMA | Air-PMMA |
|---|---|---|---|
| Signal | 134 ± 23 | 570 ± 65 | 757 ± 58 |
| (photons/second) | | | |

The concentration of the target analyte (rabbit-IgG): 10 μg/ml

The creation of guided mode resonances with high refractive index materials is directly associated with the increased extraction of light from the structure. (OPTICS EXPRESS 16, 21626-21640 (2008) The emitted light from the fluorophores confined on top of high refractive index-material is extracted via coupling to their leaky modes, leading to amplification of the emission, as long as conditions of size and periodicity are met—as they are with the smallest particle and wells that we used. The incorporation of 40 nm particles into the wells efficiently utilizes the tail of the near-field evanescent field that extends into the superstrate region (PMMA) for excitation of the fluorophores on its surface. On the other hand, for 200 nm and 1 μm wells, mode coupling was not significant as the size of the particle imposed restrictions on the periodicity and the depth of the well: these are important parameters that contribute to the formation of the guided mode resonances. (Appl Optics 4, 1275-& (1965)) For example, the depth of the periodic structure, t, must satisfy the relation λ_{G}/2>l>λ_{G}/4 for first order diffraction, where λ_{G} is the wavelength of the light experiencing the guided mode resonances. Therefore, considering the emission wavelength of Alexa-532, the effective range of the depth is 278 nm>l>139 nm. In addition, 1 μm particles incorporated into an array showed strong Mie scattering due to the large diameter of the particle (J. Opt. Soc. Am. B 9, 1585-1592 (1992)), which prevented the guided mode resonances from being created in the high refractive index-material (ITO). The Mie scattering interferes with the Bragg scattering that drives extraction of the emitted fluorescent signal. It should be noted that the guided mode resonances condition for 1 μm particles was not achieved even by increasing the depth of the periodic structure.

### Example 4

### Detection of rabbit I₂G

### Comparison Between Nanostructured and Microstructured Arrays

1 ml of 0.05% (w/v) fluorescent carboxylated polystyrene particles (40 nm, 200 nm, 1 μm and 5 μm) were coated with goat-anti-rabbit IgG by passive adsorption considering 100%-bound coverage of the antibody to surface of the particle based on particle size. The mixing time was 2 hours at room temperature followed by overnight incubation at 4° C. The mixed solution was then washed and finally suspended in DI water. After trapping the particle-goat-anti rabbit IgG into nano- or micro-wells corresponding to their sizes, 10 μl of target rabbit IgG dissolved in 1×PBS buffer was dropped to the area where total nine arrays/wells (the distance between the arrays/wells was 250 μm) were located-hence the amounts of the target molecules in 10 μl were shared by an individual array that was the unit for signal harvesting. The arrays/wells were then incubated for 20 min at room temperature followed by removal of the solution. Finally, 10 μl of 10 μg/ml goat-anti rabbit IgG-Alexa 532 dissolved in 1×PBS buffer was dropped onto the arrays/wells. The chip was then incubated for another 20 min followed by removal of the solution. Concentrations of the target were varied from 10⁻⁹ μm/ml to 1000 μg/ml while the concentration of fluorescently labeled antibody was fixed.

The single photon counting detection system was used for excitation with a 532 nm-laser and collection of 555 nm-emitted light from the immunocomplex on the detection area of the array (52 μm×52 μm; white broken line in FIG. 4A-4D).

FIG. 6 shows the standard curves for four different arrays based on the size of particles (x:40 nm, ▴:200 nm, ▪:1 μm and :5 μm). Nine different concentrations of rabbit-immunoglobulin G (IgG) dissolved in phosphate buffered saline (PBS) were detected using sandwich immunoassays: 10⁻⁹, 10⁻⁶, 10⁻³, 0.01, 0.1, 1, 10, 100 and 1000 μg/ml. A goat-anti rabbit IgG-Alexa 532 conjugate was used as a fluorescently labeled detection antibody at a concentration of 10 μg/ml. Background noise originated from the 532 nm-laser was measured by shining the laser on the arrays in the absence of particles and immunoassay reagents. The result was 13±4 photons/second. To test for non-specific binding of the fluorescent-labeled detection antibody to either the particle-goat-anti-rabbit IgG or the surface of the PMMA, the solution of the detection antibody was added to the arrays that were comprised of trapped particles conjugated with goat-anti rabbit IgG without the target (rabbit-IgG). The signal generated by non-specific binding of the detection antibody averaged 26 photons/second (background noise included) for wells of all sizes, with no statistically significant differences compared to the background noise (p<0.05). Additionally, a negative control for goat-anti rabbit IgG (capture and detection antibody) with another target (10 μg/ml of mouse IgG) averaged 19 photons/second (background noise included) for all size cases, showing that the cross-reactivity between different biological molecules was negligible. The data points on the standard curve were corrected by subtracting non-specific binding (background noise excluded) from total signals to avoid false positive results (Table 3).

TABLE 3
The datum points used on the standard curve for quantifying rabbit IgG

| | Fluorescent signal ± SD (photons/second) | | | | | | | | | |
|---|---|---|---|---|---|---|---|---|---|---|
| | 1000 | 10 | 10 | 1 | 0.1 | 0.01 | 0.001 | 10−6 | | |
| Arrays/Spot | μg/ml | μg/ml | μg/ml | μg/ml | μg/ml | μg/ml | μg/ml | μg/ml | C | SB |
| 5 μm | 135 ± 19 | 132 ± 34 | 116 ± 11 | 46 ± 28 | — | — | — | — | 18 ± 1 | 31 ± 2 |
| 1 μm | 201 ± 20 | 278 ± 0 | 246 ± 31 | 107 ± 0 | 64 ± 20 | 61 ± 5 | 43 ± 1 | — | 16 ± 5 | 18 ± 2 |
| 200 nm | 398 ± 46 | 442 ± 0 | 422 ± 31 | 344 ± 16 | 258 ± 14 | 231 ± 46 | 211 ± 0 | 89 ± 12 | 24 ± 6 | 23 ± 2 |
| 40 nm | 761 ± 57 | 762 ± 0 | 775 ± 58 | 663 ± 4 | 404 ± 0 | 365 ± 36 | 204 ± 6 | 43 ± 3 | 17 ± 3 | 31 ± 2 |

| | |
|---|---|
| BN | 13 ± 4 |

SD: Standard deviation over three replicates, NC: Negative control, NSB: Non-specific binding, BN: Background noisy

The photons of light emitted from the immunocomplex were then detected by the single photon counting avalanche photodiode which generated one pulse per photon. One datum point on the curve was obtained from averaged numbers of pulses counted for 20 seconds using the oscilloscope. LODs were determined from the signal (dash line on FIG. 6) equal to the background noise with three times standard deviation of the background noise. FIG. 6 error bars, standard deviation were determined over three replicates.

The 40 nm-nanoarray with 650 nm-periodicity showed the highest intensity of fluorescent signal from the array. The intensity decreased as the size of the wells increased. The 40 nm-nanoarray and 200 nm-nanoarray (periodicity: 2 μm) showed the lowest limits of detection (LOD) at 10⁻⁶ μg/ml, corresponding to 7 femtomolar concentration of the rabbit-IgG (molecular weight: 144 kDa), while the 1 μm (10 μm-periodicity)-microarray or 5 μm well showed 10⁻³ μg/ml and 1 μg/ml-LOD, respectively. The linear detection range was 10⁻⁶ μg/ml to 10 μg/ml (R²: 0.92 or 0.94) for 40 nm- and 200 nm-nanoarray while it was 0.1 μg/ml to 10 μg/ml (R²: 0.91) and 1 μg/ml to 10 μg/ml (non-estimated R² value based on only two datum points in the linear range) for 1 μm and 5 μm structures, respectively, indicating that the arrays pixelated with the nanoparticles showed a significantly greater linear detection range than a single microparticle in a particle based immunoassay.

### Example 5

### Optimization of Fluorescent Signal Extraction/Excitation for Nanoarray

Optimization was performed for the 40 nm-nanoarray to obtain first order diffraction (m=1) that yields the biggest enhancement of guided mode resonance for excitation (532 nm) and emission (555 nm) light. The formula applied for the optimization of the periodicity of the photonic crystal was derived from

sin(θ)=(β±m2π/D)/n₁k (1)

where θ is the angle of incidence of light with respect to the normal to the photonic structure surface. β is the in-plane propagation constant given by β=n₂k cos(φ), m is the order of diffraction, D is the periodicity of the photonic structure, k is the wave vector given by k=2π/λ, n₁ is the refractive index of the medium the light is incident, and n₂ is the refractive index of the photonic structure. (OPTICS EXPRESS 16, 21626-21640 (2008) and Ieee Journal of Quantum Electronics 33, 2038-2059 (1997)) Equation (1) applies in the limit of φ→0°, where φ is the internal diffraction angle between the diffracted light and surface; this approximation serves to provide a rough guide to designing the nanostructure. Solving for θ→0 (for normal incidence);

D=λm/n₂·cos(φ) (2)

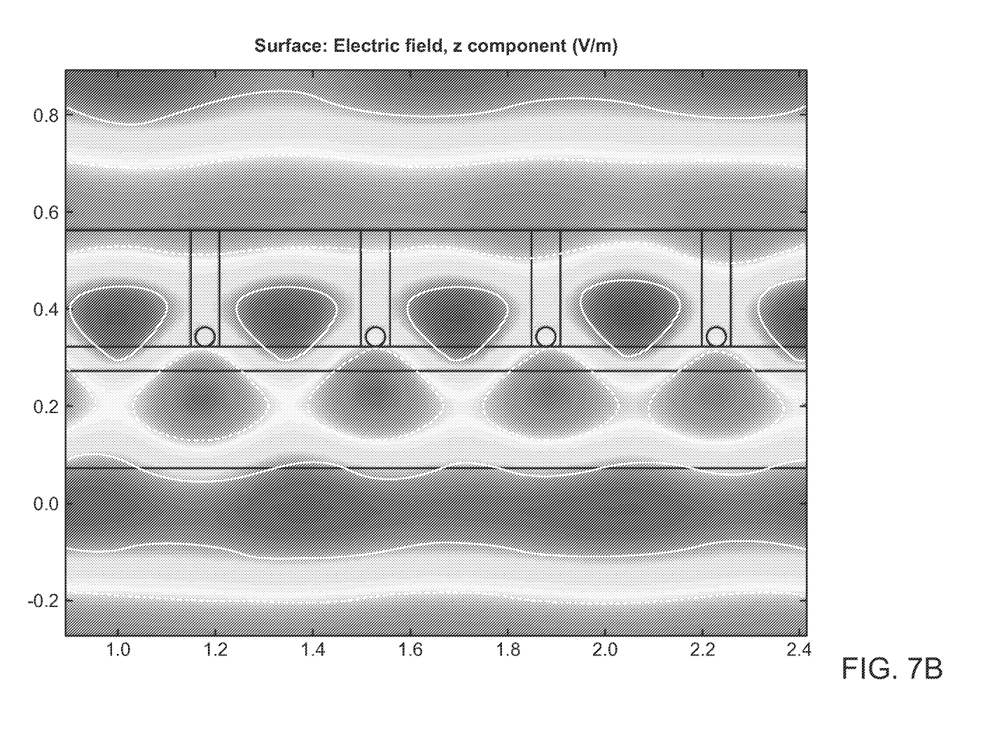

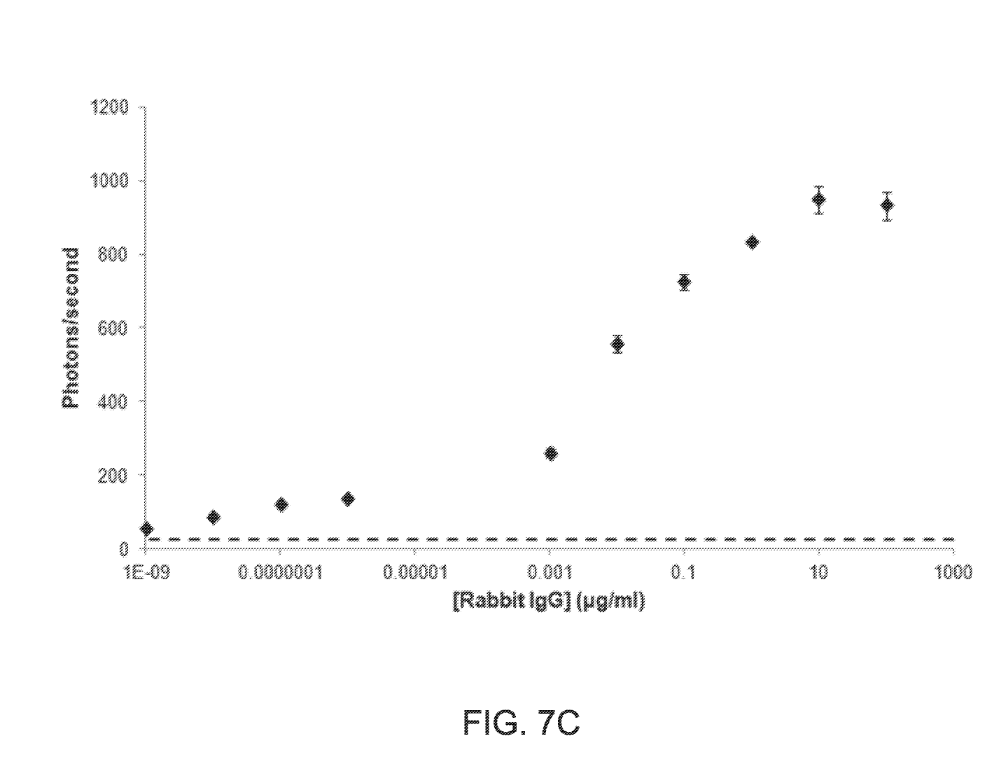

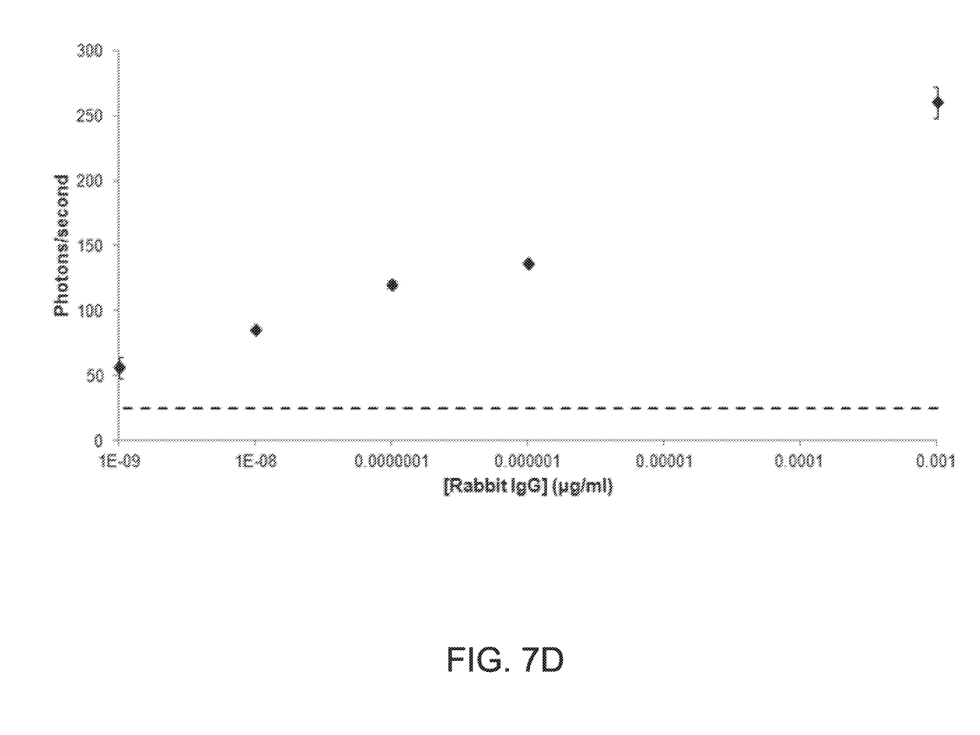

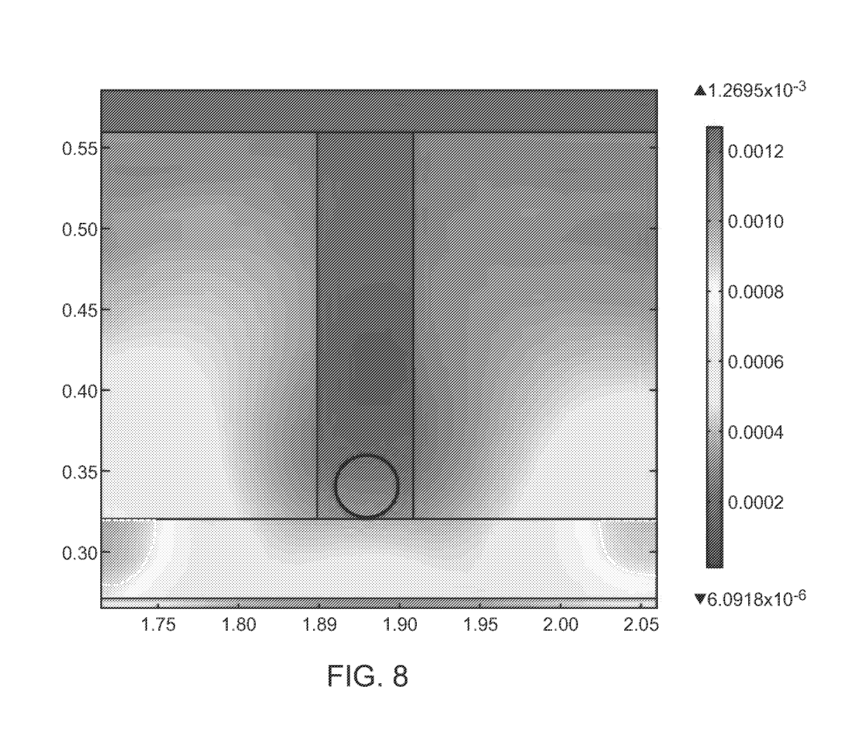

Taking an average refractive index for the photonic structure to be n₂=1.6 and taking the wavelength for excitation and emission to be 532 nm and 555 nm respectively, we obtain a value for D of ˜350 nm for first order of diffraction. A numerical model based on this structure confirmed the formation of modes within this periodic structure (FIGS. 7A and 7B). FIGS. 7C and 7D show the experimental standard curve for a rabbit IgG immunoassay using an optimized array of 40 nm wells with 350 nm-periodicity. This array of wells was compared experimentally with an array of 40 nm wells spaced with a 650 nm-periodicity so that the total surface area covered with capture antibodies was about the same. FIG. 7C shows the assay response over the concentration range (10⁻⁹ μg/ml to 100 μg/ml). FIG. 7D shows a quasi-linear response in the attomolar to picomolar range. Dash line is equal to the background noise with three times standard deviation of the background noise. Error bars i.e., standard deviations, are determined over three replicates. The LOD in the optimized array was 10⁻⁹ μg/ml, corresponding to a 7 attomolar concentration of the rabbit-IgG −1000 fold lower than of the LOD in a 40 nm-nanoarray with the non-optimal 650 nm-periodicity. Two distinct log-linear detection ranges with different slopes were found: at high concentrations (10⁻³ μg/ml to 10 μm/ml; R²: 0.95) and at low concentrations (10⁻⁹ μg/ml to 10⁻³ μm/1; R²: 0.99). The signal enhancement also depended on the choice of fluorophore used for the probe. Alexa 532 fluorophore showed the best spectral fit to take advantage of the PC structure in the optimized array because the peak wavelengths for both excitation and emission of the fluorophore was closely associated with the range of resonances as shown in FIG. 8. FIG. 8 illustrates energy density time average as a function of frequency showing resonance. Data on the graph corresponds to the surface of the particles in wells (circle).

### Example 6

### Detection of HER2 in Serum

Enhanced limits of detection can be of great benefit for the early diagnosis of disease and infection. An immunoassay for HER2 positive breast cancer in human serum provides a convenient model for testing the practical value of the PC/nanoparticle assay given the ready availability of both antibodies and target molecules in known concentrations. In practice, however, the natural background levels of HER2 may obviate the need for the reduction of the LOD to very low levels. A standard curve was prepared using the optimized array of 40 nm wells as well as conventional ELISA.

A 96-well ELISA plate (Maxisorp, Nunc) was coated with monoclonal capture antibody to HER2 at 8 μg/ml in PBS by 2 h incubation at 37° C. Non-specific binding sites of the plate were blocked with 400 μl of 1% BSA in PBS per each well, followed by 2 h incubation at 37° C. One hundred μl of various concentrations of HER2 diluted in PBS (25.6×10⁻⁶, 0.128×10⁻³, 0.00064, 0.0032, 0.016 μg/ml) were added to wells and the plate was incubated for 1 h at room temperature with gentle rocking. The plate was washed five times with PBST and 100 μl of a biotinylated polyclonal detection antibody to HER2 was added. After 1 h incubation at room temperature, the plate was washed five times with PBST and then 100 μl of streptavidin-HRP (1/6000 dilution in PBS) was added and the plate was incubated at room temperature for 1 h. The plate was washed five times with PBST and 100 μl of the HRP substrate solution (400 μl of 0.6% TMB in DMSO and 100 μl of 1% H₂O₂ solution into 25 ml of citrate buffer) was added and the reaction was stopped after 15 min by adding 50 μl of 2 M H₂SO₄ solution. Absorbance was obtained by reading the plate at 450 nm with a plate reader (Molecular device, Sunnyvale, Calif.).

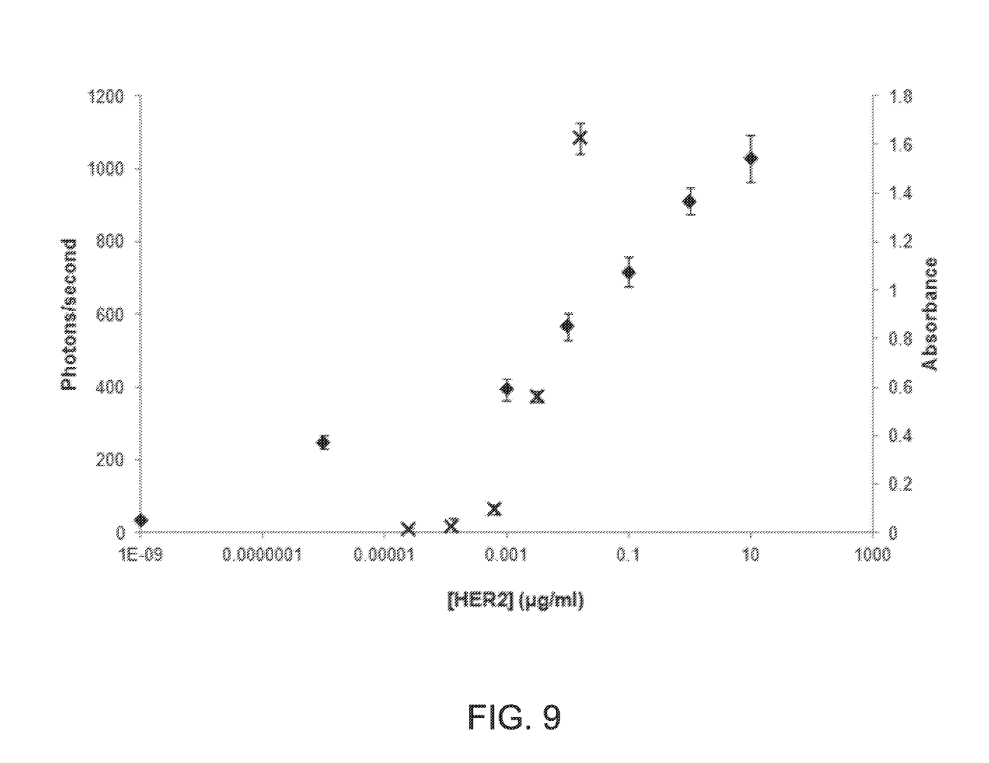

For the nanoarray-created standard curve, the recombinant HER2 was spiked to 25% human serum to show the reliability in a clinical diagnosis. The mixing ratio of serum to PBS buffer was chosen to reduce matrix effects. (Nat. Biotechnol. 28, 595-599 (2010)) The concentrations were 10⁻⁹, 10⁻⁶, 10⁻³, 0.01, 0.1, 1, 10 μg/ml. Background noise was 13±4 photons/second. Non-specific binding of fluorescently labeled detection antibody to either the particle-monoclonal capture antibody to HER2, or to the surface of PMMA, gave rise to a signal of 12±2 photons/second (background noise excluded). To test for any false-positive effect caused by the residue of either unbound HER2 to the particle-capture antibody or fluorescently labeled detection antibody in the wells after incubation followed by removal of solution, the particles without capture antibody were used for an immunoassay on the array (other conditions were same). The signal was not different from the background noise. For a negative control, non-spiked serum in PBS was used: serum contains a number of different kinds of proteins with millimolar concentrations (Wild, D. The Immunoassay Handbook, Edn. 3rd. (Elsevier, New York, N.Y.; 2005)) that could present interferences in the assay. The signal difference between the negative control and background noise was negligible at one photon/second. The test results for non-specific binding and the negative control were in the range of the background noise within three standard deviations. FIG. 9 shows the resulting standard curve for the HER2 immunoassay using the optimized array of 40 nm wells with 350 nm-periodicity (♦) as well as the standard curve obtained from the corresponding conventional ELISA (x) was compared. Error bars, standard deviation were determined over three replicates. The two distinct log-linear detection range for HER2 were found: at 0.001 μg/ml to 10 μg/ml (R²: 0.99) and at 10⁻⁹ μg/ml to 10⁻³ μg/ml (R²: 0.99). The limit of detection was 10⁻⁹ μg/ml, corresponding to a 10 attomolar concentration based on the molecular weight of recombinant HER2 (98.6 kDa, R&D systems). The LOD was 10⁶ fold lower than that of conventional ELISA (1 ng/ml).

### Example 7

### Phages as Nanoparticles in Array

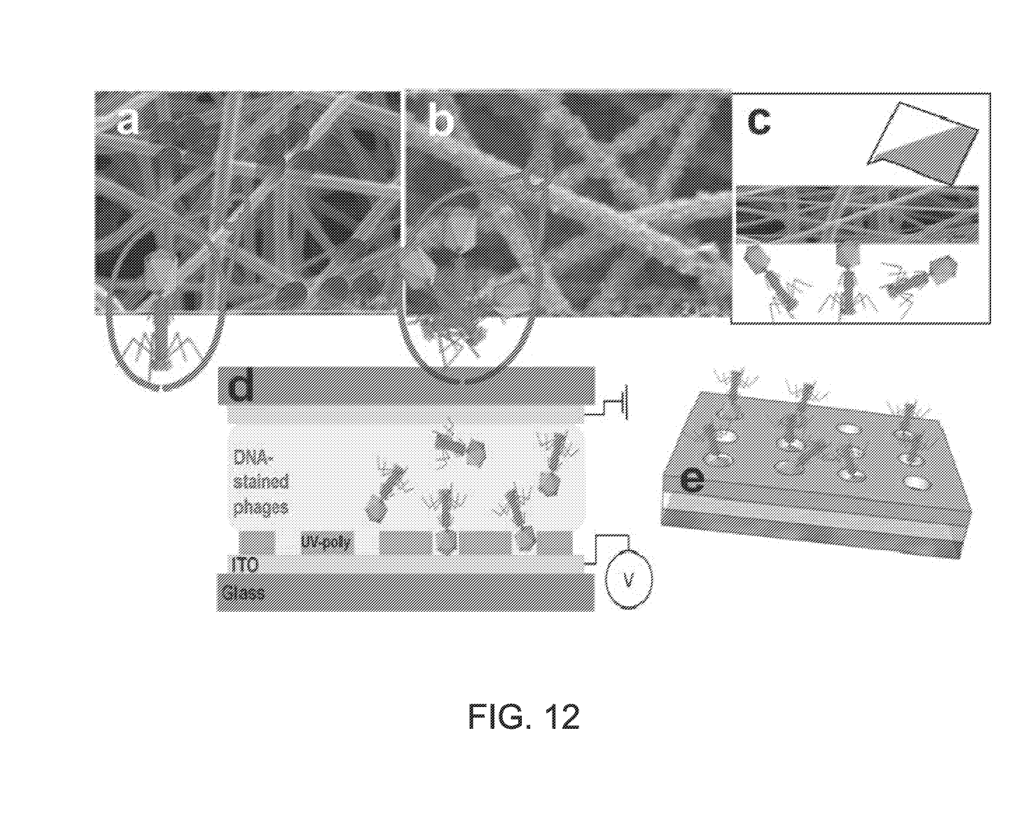

Referring to FIG. 12, pathogens are trapped on a phage coated filter (a); the phages infect the pathogens generating secondary phages (b); secondary phages are extracted from the filter (c); the secondary phages are labeled with a DNA-selective dye and electrophoretically trapped onto a photonic crystal platform (d); and the labeled secondary phages are fluorescently detected.

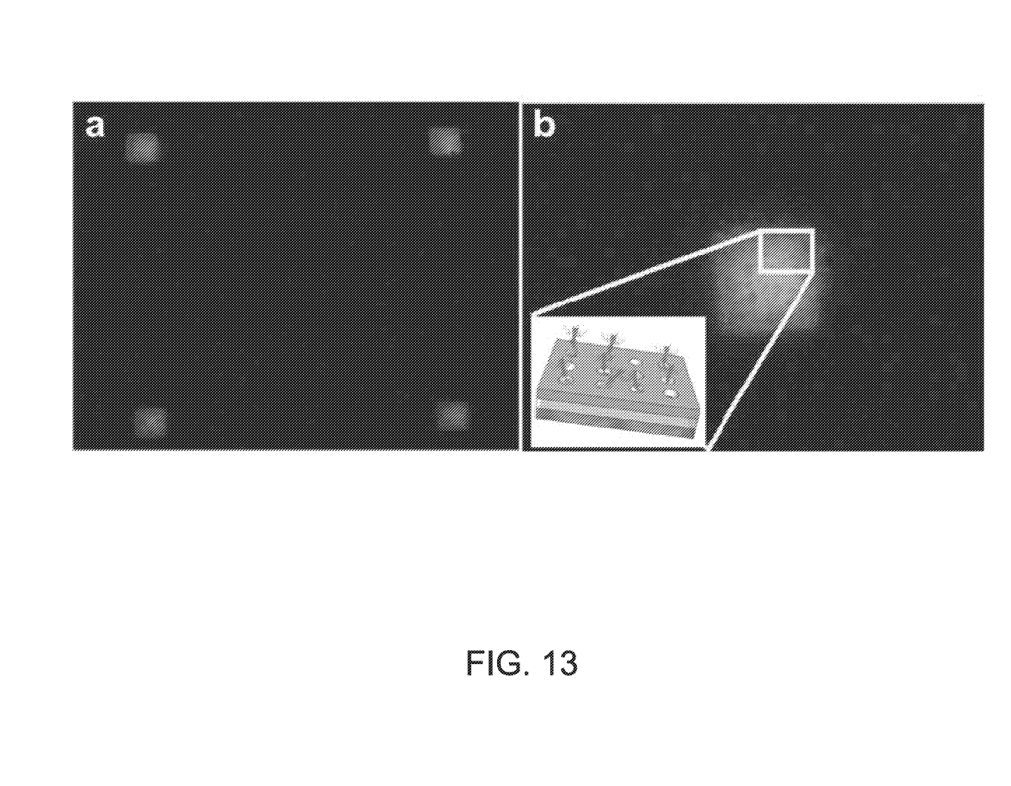

In one embodiment, a low static voltage of 2 V is applied across the photonic crystal to immobilize T7 phages onto an array. FIG. 13 are fluorescent microscope images of SYBR green labeled T7 phages trapped in a photonic crystal array (25 μm×25 μm) created on ITO coated glass slide. The periodicity of the photonic crystal was 350 nm. FIG. 13B is a higher magnification image showing a single photonic crystal array with T7 phages. FIG. 13 shows that the photonic crystal array was filled with phages at concentrations of 2.25×10¹⁰ PFU/ml.

### Example 8

### Testing Food for Contamination

Water, milk and apple juice samples inoculated with a specified concentration of non-pathogenic variant of E. coli 0157-H7 (10-103 cfu/ml) will be passed through a filter membrane with immobilized phages at specified flow rates (5 ml/min to 50 ml/min).

After initial capture of bacteria on filter membranes, the filters will be incubated for 30-60 minutes to allow for infection and amplification of phages. Amplified phages will be collected onto the nanophotonic biosensor platform by the electrophoresis technique.

### Example 9

### Testing Food for Contamination

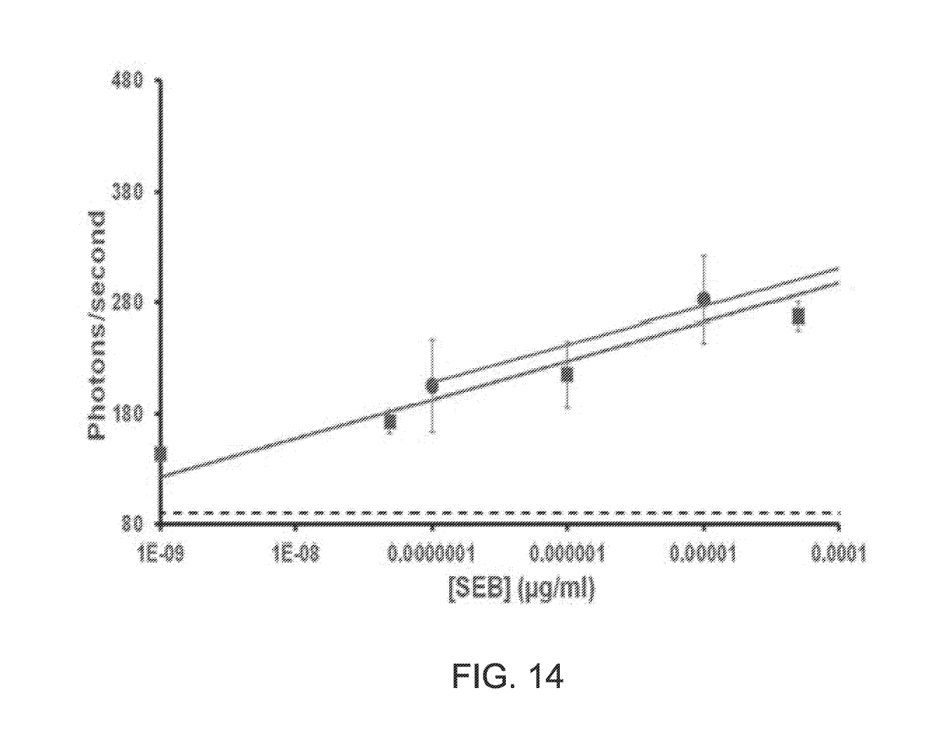

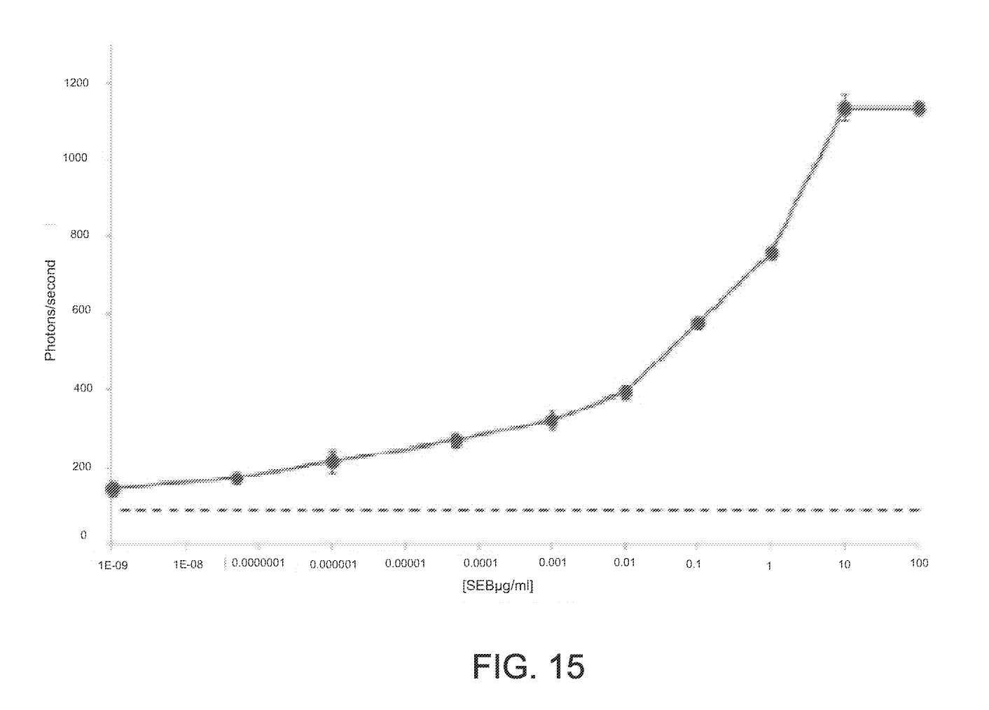

A photonic crystal in microarray format was used to determine the limit of detection of staphylococcal enterotoxin B (SEB) in PBS buffer (▪) and SEB in spiked milk (oval). FIG. 14 shows a non-competitive fluorescent-based immunoassay in the nanowell array using EPES. The limit of detection was in the attomolar range, with a large linear quantification range (nM-aM). The quantification was based on the photons emitted by Alexa532 conjugated polyclonal SEB antibody. FIG. 15 demonstrates a non-competitive fluorescent-based immunoassay in the nanowell array using EPES of SEB protein biomarker in PBS buffer.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the invention as defined in the appended claims.

1. A nanoarray comprising:
a first substrate;
a second substrate deposited on said first substrate, said second substrate having a high refractive index and having at least one of a waveguide mode or a leaky mode;
a superstrate disposed on the second substrate comprising a plurality of wells, said plurality of wells having a periodicity based on said waveguide mode or said leaky mode and one of an excitation wavelength or an emission wavelength for a signal to be measured and a nanoparticle disposed in at least one of said plurality of wells.

2. (canceled)

3. The nanoarray of claim 1 wherein said nanoparticle comprises a fluorescent tag.

4. The nanoarray of claim 1 wherein said nanoparticle further comprises an antibody.

5. The nanoarray of claim 1 wherein said nanoparticle further comprises a bacteriophage.

6. (canceled)

7. The nanoarray of claim 1 wherein the plurality of wells have a diameter of less than 100 nm.

8. The nanoarray of claim 1 wherein said plurality of wells comprise a plurality of diameters.

9. The nanoarray of claim 1 wherein said signal to be measured is an optical signal.

10. The nanoarray of claim 1 wherein said periodicitiy is based on said waveguide mode or said leaky mode, said excitation wavelength and said emission wavelength for a signal to be measured.

11. The nanoarray of claim 1 wherein said first and second substrates and superstrate comprise a photonic crystal.

12. A method of constructing a nanoarray comprising:
depositing a first substrate;
depositing a second substrate having a waveguide mode or a leaky mode on said first substrate;
depositing a superstrate on said second substrate;
determining periodicity for a plurality of nanowells to be created in said superstrate based on said waveguide mode or said leaky mode and one of an excitation wavelength or an emission wavelength for a signal to be emitted from one of the plurality of nanowells;
creating said plurality of nanowells in said superstrate, said plurality of nanowells having said determined periodicity; and
disposing a nanoparticle in one of said nanowells.

13. (canceled)

14. The method of claim 12 wherein a size of said nanoparticle is determined based upon a size of at least one of said plurality of nanowells.

15. The method of claim 12 wherein said plurality of nanowells have a plurality of diameters.

16. The method of claim 12 wherein the periodicity is determined using the equation D=λm/n₂·cos(φ) wherein D=periodicity; λ is said wavelength; m is an order of diffraction; n₂ is a refractive index of said second substrate and Φ is an internal diffraction angle between diffracted light and a surface of the nanoarray.

17. The method of claim 16 wherein said refractive index of said second substrate is 1.

18. A nanoarray comprising:
a first substrate;
a second substrate deposited on said first substrate, said second substrate having a high refractive index and having at least one of a waveguide mode or a leaky mode;
a superstrate disposed on the second substrate comprising a plurality of wells, said plurality of wells having a periodicity based on said waveguide mode or said leaky mode and one of an excitation wavelength or an emission wavelength for a signal to be measured and a bacteriophage disposed in at least one of said plurality of wells.

19. The nanoarray of claim 18 wherein the plurality of wells have a diameter of less than 100 nm.

20. The nanoarray of claim 18 wherein said periodicitiy is based on said waveguide mode or said leaky mode, said excitation wavelength and said emission wavelength for a signal to be measured.

21. The nanoarray of claim 18 wherein said first and second substrates and said superstrate comprise a photonic crystal.
